(19) United States
(12) Patent Application Publication
(10) Pub. No.: US 2022/0383303 A1
(43) Pub. Date: Dec. 1, 2022

(54) SYSTEMS AND METHODS FOR MULTIPLE LEDGER NON-FUNGIBLE TOKENS AND MULTIPLE CHAIN BLOCKCHAINS FOR USING SAME

(71) Applicant: Dynamics Inc., Cheswick, PA (US)

(72) Inventors: Jeffery D. Mullen, Glenshaw, PA (US); Jonathan L. Beaver, Cranberry, PA (US); Anthony Wentzel, North Hollywood, CA (US)

(21) Appl. No.: 17/824,678

(22) Filed: May 25, 2022

Related U.S. Application Data
(60) Provisional application No. 63/193,452, filed on May 26, 2021.

(51) Int. Cl. G06Q 20/38

(52) U.S. Cl. CPC G06Q 20/389

(57) ABSTRACT

A non-fungible token (NFT) multiple ledger processing environment is provided in which a public processing platform providing a public ledger for processing functions (e.g., ownership transactions) associated with the NFT provides entities identifiable on the public processing platform with an ownership transaction function to a public processing platform identity with a private processing platform providing a private ledger. The NFT includes data structures for such private ledgers to include private ledger data in the pubic NFT so that private transactions in the private ledger may be completed and recorded in the multiple-ledger NFT. The multiple-ledger NFT may then be, for example, transacted back to an entity identifiable on the public processing platform (e.g., ownership change) and the public ledger may continue to be utilized. In doing so, for example, a NFT may include a primary public ledger and secondary private ledgers and the same token may be transacted between users of the ledgers without requiring destruction or re-creation of the NFT from ledger to ledger. As such, for example, NFT data may be preserved through different ledgers as the same NFT may be utilized by the different ledgers. Additionally, the public processing system may utilize multiple chains of blocks for processing with third-party processor entities, where each chain may be limited in the number of third-party processor entities used, and each chain of blocks for processing may not be able to proceed to the next block until all parallel blocks in all parallel chains are processed.

### CROSS-REFERENCE TO RELATED APPLICATION

This application claims the benefit of U.S. Provisional Patent Application No. 63/193,452, titled “SYSTEMS AND METHODS FOR MULTIPLE LEDGER NON-FUNGIBLE TOKENS AND MULTIPLE CHAIN BLOCKCHAINS FOR USING SAME,” filed May 26, 2021 (now Attorney Docket No. D/190PROV), the entirety of which is hereby incorporated by reference herein in its entirety.

### BACKGROUND OF THE INVENTION

This invention relates to blockchain.

### SUMMARY OF THE INVENTION

A multiple ledger non-fungible token (NFT) is provided that includes ledger data that can be read and written by a public processing system such as, for example a public blockchain system and ledger data that can be read and written by a private processing system such as, for example, a private blockchain system. Any number of public ledgers and/or private ledgers may have data structures included in the multiple ledger NFT. For example, a single public blockchain may be utilized as the public blockchain for a multiple-ledger NFT token. One or more private blockchains may be utilized as private blockchains for a multiple-layer NFT. Persons skilled in the art will appreciate that a multiple-ledger NFT may be scalable to any private blockchain such that blockchains that are created after the multiple-ledger NFT is created can be utilized with the multiple-ledger NFT.

A multiple ledger NFT may be provided on a public blockchain that includes, for example, unique transacting entity identifiers for private ledgers as well as, for example, end users. As such, for example, end users may record changes in ownership from one user to another utilizing the public blockchain. With the addition of private ledger unique transaction entity identifier the private ledger itself may receive ownership of an NFT. The NFT may be constructed such that when the NFT is transacted to a private ledger, fields are provided in the NFT that can only be written to by the private ledger entity (e.g., are read-only to all other entities including the public blockchain). Thus, the private ledger can, for example, perform its own functions—such as functions not able to be provided on the public ledger—on the NFT as well as transact ownership and record that ownership change in the NFT as a private ledger transaction. The NFT may include a web link to the private ledger such that, for example, the private ledger can be assessed publicly. The private ledger entity may then transact the NFT to a public blockchain end user using the public blockchain (at which time, for example, the public blockchain ledger may be utilized). Ledger entries may include, for both the private and public ledgers, information on the sending entity, receiving entity, amount of transaction and any additional data (e.g., manually input or autonomously input data.

The multiple-ledger NFT may provision all private ledger entries on the public blockchain that are not on the public blockchain when the public blockchain is utilized for a transaction. Person skilled in the art will appreciate that multiple public blockchains may be utilized in a multiple-ledger NFT. A public blockchain may select a primary public blockchain, for example, such that when the primary public blockchain receives an NFT transaction request from a different public blockchain, the public ledger of the primary public blockchain may be updated with the information from the secondary blockchain. Persons skilled in the art will appreciate that a multiple-ledger NFT may be included that includes data structures in which ledgers may be written to by different blockchains. The data structures may be structured such that only the blockchain (e.g., public or private) that is associated with that ledger has the ability to write to that ledger. Persons skilled in the art will appreciate that the various ledgers may utilize different technologies to create the ledger. For example, one may use a single chain blockchain and another may utilize a multiple chain blockchain. As per another example, one ledger may utilize a secure database with token-identifiable information while another may utilized a blockchain for processing a blockchain processed non-fungible token.

A multiple chain blockchain is provided that includes multiple chains of data blocks for processing. Each chain may have a pre-determined limit of processors (e.g., miners) that process requests (e.g., ownership transition requests) of the data blocks. Accordingly, for example, each chain of data blocks may have a pre-determined limit of no more than 10, no more than 25, or no more than 100 chain processors (e.g., miners). Each chain of data blocks may have, for example, a minimum number of required chain processors (e.g., at least 5, at least 10, at least 75). Accordingly, a processor group of at least 50 and no more than 100 may be a pre-determined requirement for a chain to start processing data blocks for a multiple chain blockchain. Accordingly, a blockchain may have 5, 10, or 20 parallel chains that are being processed in parallel by different blockchain processors (e.g., blockchain miners). In doing so, for example, the processing power (e.g., environmental impact) may be reduced to process a block of data on a public blockchain of third-party processors (e.g., miners) while the speed of data processing (e.g., scalability) may be increased. Persons skilled in the art will appreciate that each independent chain of block data may have processing dependencies between the chains in order to, for example, increase security. For example, each independent chain may not be permitted to move to the next data block (e.g., the 82^{nd} data block in the chain) until all other chains have processed the same sequential data block (e.g., the 82^{nd} data block). The hashing or other processing function for each data block (e.g., 82^{nd} data block) may utilize data from every previous data block in all chains (e.g., data from all 81st data blocks). In doing so, all processors would not be able to, for example, start the subsequent data block until all current data blocks of all independently processed chains are complete. A NFT function collision avoidance process may occur in the order blocks are completed so that only one block being processed out of multiple blocks of a multiple-chain blockchain can be utilized to process a single NFT at any one time. Accordingly, if one block has a request to transfer ownership from entity A to entity B and another block has a request to transfer ownership from entity A to entity C then the first transfer request completed is accepted and the second request may be denied.

An NFT may be, for example, associated with a collectible. An NFT, however, may be associated with other types of assets such as a non-collectible data asset. A non-collectible data asset may be, for example, a monetary asset, a legal right, a physical asset, or any type of object, function, or other structure that may be associated with a token. Each token may include, for example, a unique identification such that each token is unique. A NFT may include additional data fields that may be written to, read from, or written to and read from different types of entities. For example, a NFT manufacturer may have a unique processor identifier that may not be changed by any entity. Accordingly, an NFT manufacturer may obtain software to create an NFT for a blockchain (e.g., Ethereum or another public or private blockchain) and that software may have a unique identifier (e.g., a unique wallet identifier). The NFT manufacturer may utilize the NFT software to create an NFT (e.g., a collectible NFT) and may register the created NFT software on a public ledger of a public blockchain. The manufacturer may create an NFT with fields that the manufacturer can write to and read from but that other identities may not write to and read from. Accordingly, the manufacturer may create fields that can only be updated, for example, by the unique entity identifier used to create the NFT. Such fields may include, for example, a collectible asset (e.g., one or more pictures, videos, in-game features such as weapons or characters or character skins), a website link to a hosted copy of content (e.g., a link to a website that has one or more pictures, videos, in-game features, etc.), a manufacturer's collectible identifier, status data of NFT private platform function data, private ledger information associated with a private ledger of the manufacturer, or any other type of data. The NFT may include, for example, data structures for public ledger and public blockchain features such as, for example, a history of completed functions that occurred on a public ledger.

A blockchain may have different processing packages for different types of users or functions. For example, a processing package may be provided for a user while a different processing package may be delivered for a blockchain processor and yet a different package providing access to a private ledger and yet another different software package. An end user may have multiple software packages, or access to software packages, such as, for example, a software package for each private ledger and a software package for a public ledger. A public blockchain may have a processing package for a private ledger network that, for example, permits the private ledger to provide software packages that has an identity that can transact on the public ledger as well as the public ledger as well as transact an NFT into the public network. For example, a private ledger network may have a software package with an entity “PremiumNFTLedger” that operates a private ledger. “PremiumNFTLedger” may also, for example, provide subordinate identities such as “PremiumNFTLedger.User001” and “PremiumNFTLedger.User002” that are recognizable by the public ledger as being associated by the private platform. An NFT may be created by the private platform and registered to the public platform as “PremiumNFTLedger.” The NFT may then be transacted internal to the private system (e.g., from User001 to User002”) and User002 may export to the public ledger and a private ledger data structure in the NFT may be updated with this transaction history as well as the private ledger updated with the transaction history. A public ledger may be provided, for example, that receives a transaction request from PremiumNFTLedger.User002 to provide to a user of a different private platform (e.g., “BananaNFT.User001”). As the original register of the NFT was PremiumNFTLedger and the private ledger transaction history shows that PremiumNFTLedger.User002 is the owner, then the public NFT may acknowledge the transfer request is valid as coming from PremiumNFTLedger and may permit the transaction. Persons skilled in the art will appreciate that the public ledger verification check may alternatively not be able to discern the private ledger information and may be provided to just determine if the user belongs to the private network that last owned (e.g., registered) the NFT. The public ledger, for example, may not have access to user entity information of the private platform and the private platform may, for example, transact directly with the public platform to, for example, transfer ownership to a user of the public platform or another private platform entity. Accordingly, a transaction may be directly from “PremiumNFTLeder” to “BananaNFT” through a public blockchain (e.g., Ethereum). Such an approach may reduce processing on the public blockchain and decrease environmental impact by reducing, for example, overall power expenditure. The private ledger may be provided that does not have third party processing systems for processing ledger functions and instead may provide private ledger processing itself without third party processors. The private ledger may alternatively utilize third party processing systems to provide a publicly processed ledger within a private platform.

A user may export an NFT to one or more public blockchains. A user may import an NFT from one or more public blockchains. A private platform may embed a token from one platform (e.g., a public blockchain) into, for example, a single ledger token created for another blockchain. Accordingly, for example, a user may export a multi-ledger NFT to a user of a single-ledger token blockchain by creating an NFT for that single ledger blockchain that has a field for additional data storage and copying the multi-ledger NFT into that additional data storage. The multi-ledger NFT may then be preserved in the single-ledger NFT and may be transacted as a single-ledger NFT. The single ledger NFT may have instructions recording it to unembed the token and the embedding platform may charge a fee (e.g., more than USD $0.01 or the equivalent) to unembed the multi-ledger token from a verified current user of the single ledger NFT (e.g., by verifying the current user on the blockchain of the single ledger NFT).

An autonomous NFT creation tool may be provided that utilizes a manually built NFT template to create NFTs using multiple sources (e.g., public domain sources). For example, a limited number of NFTs may be created for all bird species using photographs autonomously retrieved and configured (e.g., cropped to a particular size and converted to a particular resolution) for the NFT from one public source and description data retrieved and confirmed from another public source.

A private digital collectible platform may be provided that, for example, generates one or more NFTs for each digital collectible on the platform. Multiple NFTs may be created such as, for example, an NFT for each of multiple blockchains. The digital collectible may have, for example, a private unique identifier and this private unique identifier may be provided as a data structure in any NFT associated with the digital collectible. Digital collectibles may be grouped (e.g., into a collectible product set) and each of these groups may have an NFT, such as an index NFT, that is created and placed on a public blockchain that has a link to an image or website that includes each private digital collectible identifier for the collectibles in a set and a website link to the current transaction history for each collectible. The index file may also include, for example, additional information such as the collectible name and any other attribute associated with, for example, any collectible indexed. Accordingly, transactions of the digital collectible may be stored and may be retrieved on the public platform. A viewable collectible on the platform may therefore have an option for a user of the platform to view the transaction history. This viewable transaction history may be, for example, determined at the distraction of the user that owns the digital collectble. The user of the private platform that owns a collectible may select to export the collectible to a blockchain and an NFT for that blockchain may be generated or retrieved and filled with data (e.g., platform ledger data) and then transacted through the blockchain selected. The exported NFT may include the unique identifier for the collectible for the private platform.

At NFT exportation, consumers can be provided with an option to select the data to be placed in the NFT for export as well as, for example, the estimated cost for placing such data in the NFT. Persons skilled in the art will appreciate that the size of an NFT may change the cost of the NFT to be transacted on, for example, a public blockchain. Accordingly, for example, the consumer may be provided with the choice to include the digital collectible (e.g., digital image, set of digital images, digital video, set of digital videos, or any type of media or multiple digital media). Accordingly, for example, the consumer can select to include one or more weblinks to digital media (e.g., which may carry a relatively lower cost) r to add the digital media itself (e.g., which may carry a relatively higher cost). Additional exportation options may be provided such as, for example, the option for the owner of the collectible to select the amount of money for the transfer (e.g., for a blockchain provided that operates off user-bid transaction costs), different resolutions of media, including or not including a private transaction ledger, selecting a time of day and/or a date of the transfer (e.g., for a blockchain provided that operates off user-bid transaction costs), or any other type of exportation option.

### BRIEF DESCRIPTION OF THE DRAWINGS

The principles and advantages of the present invention can be more clearly understood from the following detailed description considered in conjunction with the following drawings, in which the same reference numerals denote the same structural elements throughout, and in which:

FIG. 1 are illustrations of platforms constructed in accordance with the principles of the present invention;

FIG. 2 are illustrations of platforms constructed in accordance with the principles of the present invention;

FIG. 3 are illustrations of platforms constructed in accordance with the principles of the present invention;

FIG. 4 are illustrations of topologies constructed in accordance with the principles of the present invention;

FIG. 5 are illustrations of flow charts constructed in accordance with the principles of the present invention;

FIG. 6 is an illustration of architectures constructed in accordance with the principles of the present invention;

FIG. 7 are illustrations of flow charts constructed in accordance with the principles of the present invention;

FIG. 8 are illustrations of flow charts constructed in accordance with the principles of the present invention;

FIG. 9 are illustrations of flow charts constructed in accordance with the principles of the present invention;

FIG. 10 are illustrations of platforms constructed in accordance with the principles of the present invention;

FIG. 11 are illustrations of platforms constructed in accordance with the principles of the present invention;

FIG. 12 are illustrations of platforms constructed in accordance with the principles of the present invention; and

FIG. 13 are illustrations of flow charts constructed in accordance with the principles of the present invention; and

FIG. 14 are illustrations of flow charts constructed in accordance with the principles of the present invention.

### DETAILED DESCRIPTION OF THE INVENTION

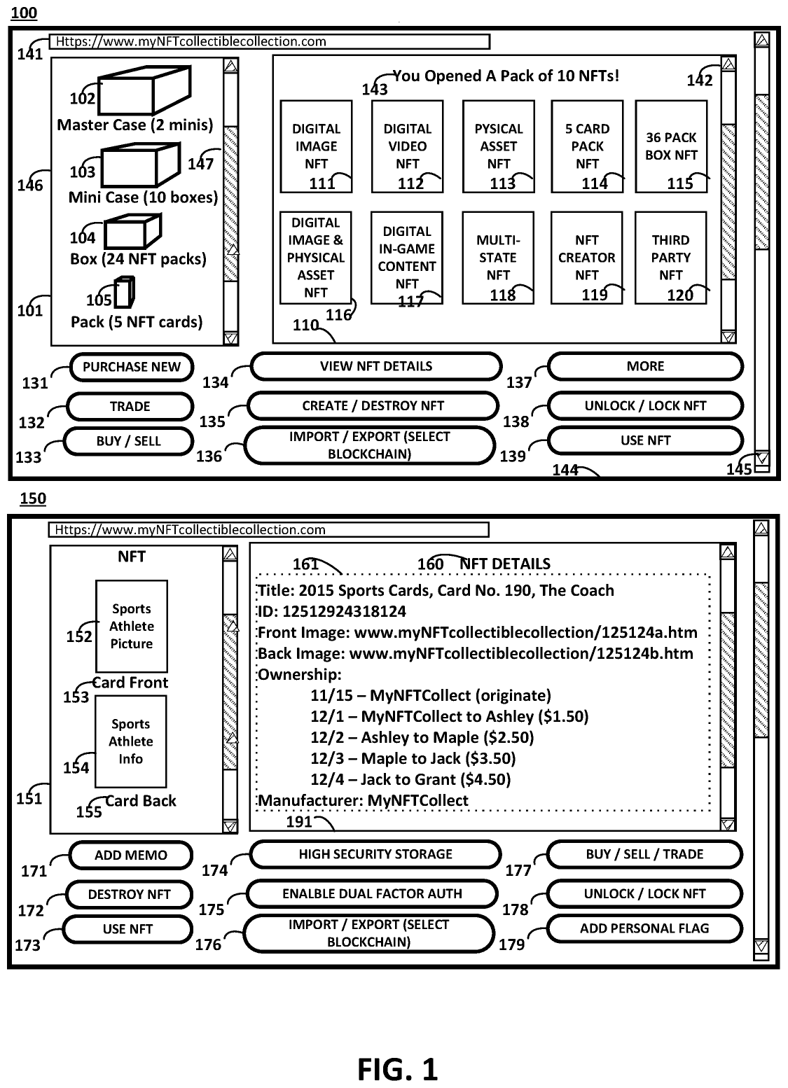

FIG. 1 shows graphical user interface 100 that may include, for example, navigational window 141, interactive window 101 and interactive window 110. Persons skilled in the art will appreciate that graphical user interface 100 may be, for example, any graphical user interface for a platform such as, for example, a webpage browser that is accessing a platform remotely over a communications network (e.g., the intranet) or any type of graphical user interface that is accessing a platform internally (e.g., on the same device as the graphical user interface) or externally (e.g., via a wireless or wire-based access) through one or more devices.

Graphical user interface 100 may be utilized, for example, with a platform for creating, organizing, and transacting digital assets such as digital collectibles. A digital collectible may be, for example, associated with a unique identifier. A public or private blockchain non-fungible token may be utilized, for example, as a structure for a digital collectible. Alternatively, for example, the digital collectible may be a non-fungible token for a non-public or non-private blockchain such as, for example, a platform that creates, organizes, and/or transactions digital assets not using a blockchain (e.g., utilizing one or more secure facilities with one or more secure databases.

A digital collectible may include, for example, media content such as, for example, one or more digital images, videos, audio segments, in-game content, or any other type of media content. The digital collectible may also include a unique identification number as well as one or more associated titles, descriptions, or other text or data. A collectible may be able to be utilized with different platforms in different ways. Accordingly, for example, platform features may have collectible status variables associated with each collectible (e.g., associated with each unique identifier). For example, a collectible may be used (e.g., with other collectibles) to perform a function. The number of times this function may be utilized may be stored in a status variable. For example, if a digital collectible (e.g., a female animal) can be bred with another qualifying collectible (e.g., digital male animal of the same species as the female animal) than the number of times the animal can be used in a breeding process may be stored as feature status data. Any number of feature status data elements may be associated with a unique identifier. A digital collectible may have multiple status identifiers (e.g., a status identifier viewer to administrators of a platform and a publicly viewable status identifier viewable to all users and/or a unique identifier for a private platform such as a public blockchain) and a unique identifier for a public platform such as a public blockchain).

A digital collectible may be, for example, associated with a physical collectible such as one or more sports card, toy, poster, comic book or other memorabilia (e.g., jersey, shoe, shorts, helmet, glove, etc.). Accordingly, a digital collectible may include both a digital asset and a physical asset. An owner of the digital collectible may at any time or in particular circumstances, request the shipping of the physical collectible. Shipping a physical collectible may, for example, destroy the digital collectible or may transition the digital collectible associated with a physical collectible to a digital collectible not associated with a physical collectible. A platform may provide a shipping interface, such as a virtual shipping button, that an owner of a digital collectible associated with a physical collectible can utilize to ship the physical collectible. An interface that displays assets (e.g., media content) from an NFT or other digital collectible may also display additional status identifiers such as whether or not a physical collectible is associated, or still associated, with a digital collectible. The content itself (e.g., a picture of a sportscard) may be altered when status changes such as, for example, a watermark indicating the physical collectible has shipped may be integrated into a picture of the digital collectible as well as additional information (e.g., date shipment was requested and/or date physical collectible shipped). Persons skilled in the art will appreciate that a digital collectible may be associated with more than 1 physical collectible. For example, a digital collectible may be associated with multiple of the same or different physical collectibles and each physical collectible may be shipped individually and/or as a group.

Collectibles, such as digital collectibles, may be exported and imported into the platform. For example, collectibles may be exported and imported into the platform using a private and/or public blockchain. The importing/exporting user may be charged, for example, an import/export fee and this fee may be different between different methods of importing or exporting (e.g., via a public blockchain or via a private blockchain). A user may also remove the collectible, such as a NFT collectible, from the platform directly (e.g., via a download of the NFT) and then may insert the collectible back on the platform (e.g., via an upload). In doing so, the user may secure store the collectible using a preferred storage medium of the user (e.g., a secure storage device of the user). Accordingly, for example, the user may take physical possession of the digital collectible (e.g., digital NFT).

A platform may generate any number of digital collectibles (e.g., over 1 million) and may release the digital collectibles as part of a themed set of collectibles (e.g., a particular sport or brand). The collectibles may be sold directly. The collectibles may also be randomized and placed into sealed packs so that a consumer purchases a pack of randomized collectibles. Digital collectibles of a particular themed set may be produced where each digital collectible has the same quantity as all digital collectibles. Alternatively, for example, digital collectibles may be created for a themed set that have different quantities than the other digital collectibles. Accordingly, different digital collectibles may have different odds associated with them and these odds may be provided to the user on a graphical user interface.

Window 101 shows interactive window 101 that includes one or more pack 105, box 104, mini case 103, and case 102. A pack may have any number of digital collectibles (e.g., NFT collectibles transactable on a public and/or a private blockchain). For example, pack may 1 NFT collectible or more than 1 NFT collectibles (e.g., 5 or more than 5 NFT collectibles).

A particular number of packs may be provided in a box. For example, box 104 may have 24 NFT packs (e.g., 24 of the type of pack of pack 105). A mini case (e.g., half case) may include a particular number of boxes of packs. For example, mini case 104 may include 10 boxes (e.g., 10 boxes of the type of box of box 104). A case may include a particular number of mini cases. For example, master case 102 may include 2 mini cases (e.g., 2 mini cases of the type of mini cases of box 103). Persons skilled in the art will appreciate that a discounted price may be given for structures that include more packs. For example, the per pack price of a master case may be less than the per pack price of a mini case which may be less than the per pack price of a box which may be less than the per pack price of a pack. Person skilled in the art will also appreciate that different types of collectibles may be guaranteed in certain types of sales bundles. For example, a particular type of digital collectible (e.g., a case insert) may be guaranteed in the purchase of a master case but not in the purchase of a mini case.

All of the collectibles of a set of collectibles may be produced and collated into packs and pack-bearing structures before the issuance and/or sale of a single pack. Producing an digital collectible may include, for example, creating a blockchain-based NFT and registering that blockchain-based NFT on a blockchain. For example, a collectible manufacturer may create a million NFT collectibles on a public blockchain using software identifiable only to the collectible manufacturer and then put those NFTs into packs (which may or may not be an NFT itself). As a result, for example, a user may be able to see all of the digital collectibles in packs before the packs are actually opened so a user can see all of the digital collectibles in the set before any of the digital collectibles are offered for sale or sold.

Each collectible, such as each NFT, on a private platform may have a transaction history that is viewable on the platform (e.g., for a user identifiable on the platform such as a user that has a login on the platform) or viewable through a platform where the user does not need to be identified (e.g., a public website). The transaction history may include, for example, when the digital collectible was created, any trades of the digital collectible between users, any sales/purchases of the digital collectible between users, any platform features that were utilized (e.g., a redemption of a platform feature occurred), any additional events as well as associated information (e.g., price of any transaction, tax of any transaction, etc.). Transaction history for a collectible (e.g., a digital NFT collectible associated with a physical collectible) may be viewable based on the collectible, set, or other filtered attributes (e.g., a player name, a year of creation/issuance, a team name, etc.). Data analytics, such as statistical graphs, may also be provided with respect to transactions anchored on one or more filter terms (e.g., transactions anchored around a user such as number of purchases over time, average price paid over time, number of sales over time, average price sold over time, number of packs or digital collectibles purchased from the collectible manufacturer ver time, etc.).

An index for a set of all collectibles of a set may be generated and published (e.g., for private view of users of a private platform such as a privately identified individual on a website or public view on a website accessible by anonymous, unidentified users). Persons skilled in the art will appreciate that the expense to create/register an NFT on a public blockchain may include a cost. Accordingly, an index NFT may be created for a grouping of NFTs such as a particular set of NFTS (e.g., a 2021 issuance of a particular set for a collectible brand). The index NFT may be searchable on the public NFT and the index NFT may include, for example, a website link that provides all of the collectibles of that set and associated information including up-to-date transaction information. Such an index NFT may be created on a public blockchain after the NFTs are created and before the NFTs are sold (e.g., through packs and boxes). Accordingly, an entity may search a public blockchain (e.g., Ethereum classic or Ethereum2), locate the index NFT and be able to reach a website that includes all of the NFTS of a grouping (e.g., a product set) and retrieve information associated with each NFT (e.g., transaction history). Person skilled in the art will appreciate that an index NFT may direct an entity to a website that shows all NFTs but only shows certain information after the NFT is purchased or opened from a pack. Accordingly, for example, a unique identifier for each NFT may be accessible for all NFTs but certain information such as a NFT name, sub-set name, transaction history may not be retrievable until the NFT is purchased or opened from a pack.

Alternatively, each digital collectible for a product set may be created/registered directly on a public blockchain. Each digital collectible may include, for example, a data structure for transactions on the public blockchain and also a data structure for transactions on a private blockchain and/or a website link to a private ledger for transactions with that NFT. Accordingly, NFTs may be created on a public blockchain before being randomized and/or collated under collation rules, and placed into packs, boxes, mini-cases, cases etc. that were already placed on a public blockchain. Alternatively, for example, some or all of the NFTs in a product issuance may, for example, be created on a public blockchain after they are purchased or opened from packs. Accordingly, a digital collectible may be provided in packs and then a public NFT may be created after the packs are opened (e.g., created by a public blockchain wallet identifiable to the user that opened the packs). Persons skilled in the art will appreciate that NFTs may be created by public blockchain software (e.g., a blockchain wallet) associated with a single entity (e.g., “bananaNFT”). The NFT may then be transacted on a ledger (e.g., a private platform) different than the ledger it was created/registered on (e.g., a public blockchain). In doing so, for example, costs and environmental impact may be reduced and transaction speed may be increased. The users of the private platform may have private wallets, public wallets, a combination of private or public wallets, or no wallets. At any time, the digital collectible (e.g., an NFT) may be exported outside of the platform with the ledger different than the public ledger. Accordingly, for example, an NFT may be exported out of the private platform through a public blockchain after it was purchased, opened from a pack, and transacted a number of times between different users (e.g., ownership changed more than 10 times). The exported NFT may include data such as a website link of the private transaction history that occurred outside of the public blockchain or may include the private transaction history itself. As the NFT was created on the public blockchain under the public blockchain software associated with the same entity as the entity exporting (e.g., “BananaNFT”) the blockchain may accept the transaction as the ownership chain is consistent from the perspective of that blockchain. In doing so, for example, a private platform may not require any user to have public blockchain software identifiable to that user for the blockchain associated with the creation of the NFT even though the NFT was created before being placed into packs and even after the NFT was transacted a number of times between different users.

Multiple NFTs for different public blockchains for a single digital collectible may be created and a user may be provided with a choice of different public blockchains to export the digital collectible through. At time of export, the NFT associated with the blockchain desired to be exported may be utilized to add private ledger transaction information for that collectible and transacted. In doing so, for example, a user may select different blockchains based on cost and may retain a creation date before the digital collectible was purchased from the manufacturer or opened from a pack. Accordingly, for example, a user may select a blockchain that has an advantage to that user (e.g., a lower transportation cost or a beneficial feature such as a beneficial security feature). The exported NFTs can then be transacted any number of times on the public blockchain and then imported back into the private platform (e.g., a private blockchain). Once in the private platform, users may continue to transact and the private ledger associated with that collectible may continue to be updated.

Persons skilled in the art will appreciate that an non-NFT digital collectible may be created for a product issuance and randomized and/or collated into product sales structures (e.g., products, boxes, mini-cases, cases). If an exportation is desired, an NFT associated with a desired exportation medium (e.g., a public blockchain) may be created (e.g., an NFT with a smart contract may be created). In doing so, no NFT may need to be created until, for example, an exportation is desired. In doing so, for example, a creation/registration date on a public blockchain may take on an exportation date which may be after the NFT is purchased or opened from a pack.

NFTs may be provided in an NFT such that nested NFTs are provided. For example, a collectible may be an NFT and product sales structures (e.g., packs, boxes, mini-cases, and cases) may also be NFTs. NFT indexes may be provided for each nested layer. Accordingly, for example, a user may buy a case as an NFT and open that NFT to reveal the mini-case NFTs. The user may then keep on mini case and trade the other mini case to a user for a different type of collectible not associated with the issued set of collectibles for the mini-cases. The mini-case that is retained may be stored for a period of time by the user (e.g., more than a year) and then opened to reveal NFT boxes. The user/collector may then sell all of the NFT boxes and keep an NFT box. A period of time later (e.g., over a year), the user may then open up the NFT box to reveal NFT packs and then may open the NFT packs to reveal NFT collectibles. Any NFT may be sold (e.g., for monetary value) or traded (e.g., for other NFT and/or non-NFT collectibles) between users. Transactions (e.g., trades) between more than two parties may be provided (e.g., a three, four, or more than four party trade may be provided). A transaction may be a partial trade/sale where a portion of the received value for one or more collectibles is monetary value and another portion of the received value is non-monetary value.

A user may select an item in interactive window 146 and may, for example, perform actions on the item using a virtual button. An auction may autonomously execute or an additional graphical user interface may be introduced with one or more additional manual input requirements and/or options.

Purchase new option 131 may be, for example, a virtual button on a graphical user interface such as a interface on a mobile phone or computer. Purchase new option 131 may, for example, initiate a purchase process for a selected item such as an item selected in interface window 146. A purchase price may be autonomous based on, for example, a stored platform value (e.g., credit or cryptocurrency associated with a platform) or through an external funding source (e.g., a credit card, debit card, bank account, etc). Persons skilled in the art will appreciate that purchase new option 131 may introduce additional manual input requirements or options such as, for example, selecting of a payment funding source, adding a funding source, or information needed to complete a transaction from a funding source (e.g., the entry of a security code for a payment card such as a CVV or CVC security code). A shopping card may be provided such that, for example, multiple products may be added (e.g., through an add to shopping card option).

Once a sales product is purchased, the product can be stored until a time that a user desires to open, trade, or sell the product. For example, a user may purchase a box of packs of NFTs and may store the box for a period of time (e.g., a year) and then trade the box to a second user and that second user may sell the box to a third user and the third user may open the box and the associated packs. An interactive window may be utilized to view purchased inventory of digital collectibles (e.g., non-NFT digital collectibles, NFT digital collectibles, digital collectibles associated with one or more physical collectibles). Option 131 may be utilized, for example, to initiate a trade with one or more digital collectible and option 133 may be utilized, for example, to initiate a purchase and/or sale of one or more digital collectibles.

NFTs from a sales product that has been opened may be shown in interactive window 110. A users collection of digital collectibles may also be shown in an interactive window (e.g., interactive window 110).

A pack of digital collectibles, or any other grouping or bundle of digital collectibles, may have the same type of digital collectible or a variety of different types of digital collectibles. For example, a pack may include one or more digital image NFTs 111, digital video NFTs 112, physical asset NFTs, grouping or bundle collectibles such as five digital card pack NFT 114, thirty-six pack box NFT 115, digital image and physical asset NFT 116, digital in-game content NFT 117, multi-state NFT 118, NFT Creator NFT 119, third party NFT 120 and/or any other type of digital collectible or other asset.

Digital image NFT may include, for example, one or more digital images. The digital images may be, for example, square, rectangular, or another shape (e.g., non-rectangular shape). The digital images may be of, for example, digital posters, postcards, trading cards, tickets, etc.). For example, a digital image NFT may be a digital trading card with an obverse image and a reverse image. Persons skilled in the art will appreciate that digital image(s) may be provided in the digital collectible or a location where the digital collectibles are located may be included (e.g., a website address for a obverse image of a trading card and another website address for a reverse image of a trading card). Persons skilled in the art will appreciate that an image may be included in an NFT that has multiple resolutions. Accordingly, a website link for a low resolution and a website link for a high resolution of an image. For example, a high resolution image may be stored in an NFT and a low resolution image may be provided via a website link.

Digital video NFT 112 may be provided and may include one or more digital videos. Digital video(s) may be, for example, square videos, rectangular (e.g., widescreen) videos, and may be provided in landscape and/or portrait perspectives. Multiple versions of the same video may be utilized in an NFT such as multiple color schemes, resolutions, frame rates, etc. Accordingly, for example, a high quality video (e.g., high resolution and/or high frame rate video) may be stored in an NFT and a lower quality video may be included in an NFT as a website address to an externally stored version of the video. In doing so, for example, a low quality version of a video may be publicly accessible but a highly quality version may be reserved to the entity that owns the NFT.

Physical asset NFT 113 may be a digital collectible that is associated with a physical asset. For example, a virtual trading card NFT that includes an image of a physical trading card and NFT may provide ownership of that physical trading card. A digital collectible associated with a physical collectible may be, for example, utilized to ship the physical collectible from a remote warehouse. Accordingly, a digital collectible associated with a physical collectible may be purchased in a randomized pack, opened, traded between users any number of times, sold between users any number of times, and then shipped at some point by a user to a shipping address of the users choosing.

Pack NFT 114 may be, for example, any type of bundle of NFT collectibles of the same or different collectible types (e.g., trading cards and posters) which may be randomized or non-randomized. For example, pack NFT 114 may be a complete set of a grouping of collectibles (e.g., trading cards) or a random assortment from a larger set of collectibles. Persons skilled in the art will appreciate that a physical pack or box of cards may be associated with an NFT where the collectibles inside the pack (e.g., individual cards) or the collectibles inside the box (e.g., individual packs) do not have an NFT associated with them. Accordingly, for example, a user that owns such a collectible NFT may ship the pack or box itself to a shipping address of their choosing. Box NFT 115 may include, for example, any number of packs of digital collectibles (e.g., packs of NFT collectibles).

Digital image and physical asset NFT 116 may be included and may include one or more digital images (e.g., website links to the obverse and reverse side scans of a physical trading card). Person skilled in the art will appreciate that additional media may be included in NFT 116 such as one or more videos (with or without audio) as well as audio-only media segments. Accordingly, for example, a trading card for a particular sports athlete may be provided as an NFT that also includes audio of that sports athlete.

Digital in-game content NFT 117 may be included.

Multi-state NFT 118 may be included and may include an NFT with multiple states such as, for example, an animal that starts off as an egg and then, over time or at some event, upgrades to a young version of the animal and then, over time or at some event, upgrades to an adult version of the animal. Various media content (e.g., images) and platform specific feature variables may be associated with the state the NFT at a particular time. Multi-state NFTs may be one-time use states or multiple time use states. For example, a animal NFT that has grown from an egg to a young animal to an adult animal may be, if a time has passed without an action, for example, downgraded from an adult animal to a young animal to an egg. Persons skilled in the art that a platform generating the NFT may be, for example, the only platform that may change the state of the NFT and, for example, an exportation of the NFT to a different platform may permit the NFT to be purchased/traded/sold on that other platform but specific platform states and features associated with the NFT generating platform may not be accessible. Persons skilled in the art will appreciate that a platform (e.g., a private platform) may provide NFT application interfaces such that third party platforms may be able to provide such features and states (an the execution of a feature or state may involve an autonomous importation into the generating platform, autonomous performance of process, and then autonomous exportation back to the requesting platform)

NFT creator NFT 119 may be included and may be an NFT that may be able to create additional NFTs. Persons skilled in the art will appreciate that an NFT creator NFT may have, for example, a platform function variable with a value equal to the number of times an NFT can be created or data on the NFTs that can be created. A request from an owner of the NFT to generate an NFT may for example change value stored in the NFT for generating NFTs. For example, if a red robin bird NFT in an adult state may lay six red robin bird NFTs in egg state each year and an owner requests an egg be generated, then the available eggs value may be updated from 6 to 5 until a year has passed, in which the value may be updated back to 6. Persons skilled in the art will appreciate that an NFT creator NFT may alternatively, for example, include NFT nesting such that, for example, a red robin bird NFT includes thirty red robin bird NFTs in an egg state. The red robin bird NFT may autonomously increase states after a period of time (e.g., 1 year) and a red robin bird NFT may start as an egg state and then move to a young bird state and then move to an adult bird state. The adult bird state may include the ability to lay six (6) red robin bird NFTs in egg states per year.

Third party NFT 120 may be included. A pack of NFTs may include, for example, NFTs from a single third party, NFTs from multiple third parties, or NFTs from the platform creating the NFT pack as well as NFTs from one or more third parties. NFTs may, for example, purchased in the secondary market and re-packed into packs. Similarly, for example a box may include pack NFTs from multiple different third parties. Accordingly, third party packs may be purchased in the secondary market and utilized to created a re-packed product. Accordingly, for example, a sales product set may be a repack set of digital collectibles purchased on the secondary market (e.g., more than 10,000 digital collectibles or more than 50,000 digital collectibles) and an index may be provided and a private ledger may be kept for the transactions for each of the third party NFTs on the platform that is accessible and viewable by all users of the platform and/or published (e.g., via a website) for anyone having access to the internet.

Person skilled in the art will appreciate that a platform may utilize NFTs with more than one ledger (e.g., two, three, or more than three ledgers). For example, a platform. Dual ledgers (for platform NFTs and third party NFTs) may be utilized for a digital collectible. For example, a digital collectible created by BananaNFT.com on a public blockchain (e.g., Ethereum) ledger may have a second blockchain or non-blockchain ledger on BananaNFT.com. Transactions on BananaNFT.com digital collectible may therefore be recorded in a private ledger and utilized for any reason such as, for example, to update a data field on an NFT at time of export from BananaNFT.com to another platform with the private ledger or, for example, to add data to a data field on a new NFT on a different public blockchain if at the time of export a different public blockchain is desired (and the original NFT on the original public blockchain may be destroyed/inactivated/burned or otherwise rendered inoperable and this inoperability recorded on the public blockchain (e.g., in an additional data field and/or as a ledger function of the public blockchain and/or if the NFT has a link to a webpage for a private ledger an update to that private ledger accessible on the NFT through the webpage link). Accordingly, a ledger on a platform such as a private platform may be used as a primary ledger when a digital collectible is on the platform. Accordingly, for example, a third party NFT may be imported into the private platform and the imported platforms ledger may record transaction activities while on the imported platform on the imported platform ledger. Persons skilled in the art will appreciate that that a platform may update multiple ledgers at the same time. For example, a private platform (e.g., BananaNFT.com) may update a private ledger (e.g., BananaNFT.com ledger) after a transaction for an NFT while also updating a public ledger (e.g., Ethereum). Persons skilled in the art will appreciate that updating the public ledger may be performed in a variety of ways such as for example updating a public ledger using a wallet (e.g., if applicable for that public ledger) for the users involved in a transaction (e.g., if the transaction was a two party transaction involving those users). Alternatively or additionally, for example, if the NFT was created on the public ledger by BananaNFT.com then BananNFT.com could utilize its own wallet for the public ledger to update a BananNFT.com only writable field with an updated transaction history for a transaction for two users. In other words, for example, users of a private platform may not be provided or provided access to wallets for a public ledger (e.g., if the public ledger utilizes a wallet structure) to record transactions and the private ledger itself may record transactions such as recording transactions in data fields accessible only to the private platform wallet for the public ledger. Similarly, when a third-party imported NFT may be imported by the private platform using the identity of the private platform as the importer. Once on the private platform, the private platform may utilize a private ledger for updated transactions. At exportation, the third-party NFT (e.g., an NFT created by a third party) may be exported by the private platform. Persons skilled in the art will appreciate that a public ledger may not be updated with all transactions on a private ledger. Accordingly, for example, transaction activities on a private ledger (e.g., BananaNFT.com) may be kept private from a public blockchain (e.g., Ethereum) while still preserving the NFT so it can be imported and exported between the private platform and Ethereum, for example, any number of times. Alternatively, for example, the third party NFT may be updated with data if, for example, the private platform (e.g., BananaNFT) has a data field the private platform is able to update. Persons skilled in the art will appreciate that a public blockchain may, for example, keep an entire record of an NFT with all data fields on all processors of the public blockchain (e.g., miners) in certain parts of its code or data so any part of any NFT on the public blockchain can be located at any time (e.g., so long as the NFT has been updated on the public blockchain).

Option 134 may be utilized, for example, to view the NFT details of a particular NFT. Such NFT details may include any information on the NFT as well as additional information (e.g., information about NFTs of the same player, set, product year, etc.).

Option 135 may be utilized, for example, to initiate an NFT creation process for a user or delete an NFT. A process for creating an NFT may include, for example, obtaining content (e.g., media content such as a video) as well as a title. Deleting a NFT may include, for example, deleting an NFT from a platform (e.g., a private platform) or disabling it so it can no longer be transacted to another entity.

Option 136 may include an option to import and/or export a collectible, such as a digital collectible, from one or more blockchains. Persons skilled in the art will appreciate that an importation and/or exportation may occur one at a time or in bulk (e.g., more than one such as more than ten).

Option 137 may be included on any interactive screen such as a screen displayed on a computer (e.g., a laptop) or a mobile telephonic device. Option 137 may be included to, for example, open a new interactive graphical interface or expand a interactive graphical interface to include additional options. In doing so, option 137 may be utilized to reduce the size of a graphical user interface and/or include the ability to include additional options not, for example, able to fit on a graphical user interface. Persons skilled in the art will appreciate that option 137 may be dynamic and may change based on a type of device that is sensed by a platform. For example, a mobile telephonic phone may be sensed (e.g., via an internet connection) and may be provided with a graphical user interface that includes option 137 and when a home computer is sensed (e.g., via an internet connection) a graphical user interface may be provided without option 137.

Option 138 may be utilized, for example, to initiate a lock or unlocking capability. A digital collectible, for example, may be locked to prohibit a feature such as, for example, the collectible being viewable on a platform, being tradeable on the platform, being sellable on a platform, being exportable on a platform, and/or any combination of these as well as additional capabilities. Any feature associated with any option may be utilized to perform the feature on one collectible or more than one collectible. For example, a user may select any number of collectibles and use option 138 to apply a lock or unlocking feature to all selected collectibles. Persons skilled in the art will appreciate that option may be two options such as a lock option and an unlock option. If a group of collectibles are selected and a lock option is utilized and a few of that group of collectibles are already locked, then only, for example, the unlocked collectibles may be locked. Person skilled in the art will appreciate that additional security may be associated with a lock and/or unlock feature such as an additional password or a randomized one-time use password (e.g., a dual-factor authentication process). Accordingly, for example, a consumer may lock a subset of collectibles utilizing a dual factor authentication (e.g., a one-time use password being emailed to the user's personal email or sent via a text message to the user's personal cell phone) so that the subset of collectibles, for example, require the same dual-factor authentication (or a different security layer) to unlock so a capability (e.g., trade, sale, and/or export) may be performed. In doing so, a consumer can select certain collectible to have heightened security and certain collectibles to have a faster, for example, transaction capability (e.g., trade, sale, and/or exportation)

Persons skilled in the art will appreciate that digital collectibles may have particular platform features or other features. For example, an NFT may be utilized to perform an action in a video game. An NFT feature may be utilized, for example, via option 139. Any number of options may be included to use a feature of an NFT. For example, if an NFT has 10 platform and/or NFT features, that NFT may have 10 separate interfaces for receiving manual input to utilize such features. Persons skilled in the art will appreciate that certain features may not be available until eligibility requirements are met. Such eligibility features may be, for example, time-based and/or event-based. An option that is not available for utilization as a result of eligibility requirements not yet being met may be viewable. For example, an option that is usable dependent on eligibility requirements may have a certain appearance (e.g., color) when the eligibility requirements are not yet met and the status of the eligibility requirements may be displayed to the consumer so the consumer can, for example, understand what needs to be accomplished to meet those eligibility requirements.

FIG. 1 shows graphical user interface 150 that may include, for example, interactive window 151 and interactive window 191. Graphical user interface may be utilized, for example, to show details and options for a collectible such as a digital NFT collectible. Interactive 151 may display, for example, media content associated with the collectible, such as a digital NFT collectible. A digital trading card, for example, may be a digital sports card that includes obverse image 152 and reverse image 154. Obverse image may include, for example, a number of attributes such as a picture of a sports athlete, name of the sports athlete, product brand, and/or product brand manufacturer's name. Obverse image 152 may include a description that may be displayed description 153. Reverse image 154 may be associated with description and may include, for example, a number of attributes such as a picture of a sports athlete, name of the sports athlete, product brand, performance such as performance in a certain year or in certain years, and/or product brand manufacturer's name. Persons skilled in the art will appreciate that media 152 and may be stored in an NFT or may be referenced in an NFT to where the media is stored. For example, an NFT may include a webpage address for each media content. Accordingly, a graphical user interface may look for webpages and retrieve and display the media content from the webpages stored in the digital NFT collectible.

NFT details 160 may be included and may include attributes such as attributes 161. Attributes may include, for example, a collectible title for the NFT collectible (e.g., a collectible card nane), a collectible number from a set of collectibles (e.g., a card number from a set of cards), a sub-set and/or insert set name, a year of manufacture, a unique identification number, a first media content and/or an internet and/or platform-specific address for retrieving a first media content, one or more additional media contents and/or an internet and/or platform-specific address, ownership history (e.g., origination and trades and/or sales and associated information (e.g. sales price, transaction fees, tax, etc.). Digital NFT attribute may include additional information such as, for example, collectible manufacturer name, collectible platform origination name, and any other information associated with a collectible, collectible owner, and/or collectible platform.

Persons skilled in the art will appreciate that transaction history may be stored in a digital collectible such as an NFT collectible, may be provided across one or more accessible databases and may be displayed to a consumer through a variety of interfaces such as a website. Persons skilled in the art will appreciate that a collectible manufacturer may be provided with a transaction history entry for the origination of the collectible as well as the initial transaction from the collectible manufacturer to the user that either purchases the original content or user that opens the original content from a sealed pack. Accordingly, for example, a collectible manufacturer may sell a collectible as part of a pack to a user and the user can hold the pack as well as trade the pack but the initial ownership past that of the collectible manufacturer will not be recorded until the collectible is removed (e.g., opened) from the pack so that, for example, the identity of the collectible is revealed to a user.

Option 171 may be included and may be, for example, an option to add a memorandum (e.g., a note) for to a digital collectible or an action or feature associated with a digital collectible. For example, an owner of a digital collectible may add a personal note that on the only can see (e.g., and only when the owner is in possession of the NFT or even after the owner transfers possession) or that all users can see. For example, a note may include any information such as, for example, a note about a purchase (e.g., a price paid) or collectibles that an owner would be interested in obtaining in exchange for the collectible. A user may be provided with an option to make a note publicly viewable to all users on a public website, publicly viewable to all users of a platform (e.g., a private website that requires a login/password to view the data), or just viewable to the owner or a list of specific users created by the owner. Any number of memos may be added to a collectible (or a grouping of collectibles). A memorandum (e.g., a note) may also be added to any transaction may be permanently added to an NFT as a result of the transaction. For example, persons skilled in the art will appreciate that a public blockchain may not require, for example, a price paid. A note may include, for example, a purchase price and/or tax amount and/or shipping cost. In doing so, additional information may be added to a transaction history (e.g., on a private and/or on public ledger and/or stored in the NFT itself). Persons skilled in the art will appreciate that a note may be autonomously generated by a platform (e.g., a private platform) and may be autonomously added to any blockchain, any ledger, and/or the NFT itself (e.g., the smart contract itself). For example, an exportation of a digital collectible from a system on a public blockchain may not have any cost associated with it on the blockchain transaction (e.g., regardless if it was purchased or traded) but the exporting system may add a transaction note that includes information such as the last price (if applicable) paid for the collectible on the platform and/or the last user that owned the collectible on the platform. Accordingly, additional information may be conveyed and stored with the NFT or on the public blockchain by storing a memorandum (e.g., a note) in a digital collectible (e.g., an NFT digital collectible smart contract).

Option 172 may be provided to destroy an NFT. An NFT may be destroyed, for example, by deleting it from a system (e.g., a private system). Person skilled in the art will appreciate that a destroy functionality may permit a user to purchase all of a players collectibles of a particular product and/or subset and destroy all of those collectibles but for a single collectible. Persons skilled in the art will appreciate that a transaction history for such a collectible may be maintained and an entry may be added that includes, for example, information regarding the destruction such as the date and time of the destruction as well as the owner of the collectible when a destruction was requested (e.g., and any memo or reason for the destruction).

Option 173 may be utilized, for example, to utilize an NFT in a particular manner or a feature of an NFT in a particular manner. For example, an NFT may be utilized to provide a non-permanent impact to a video game. For example, an NFT may be one or more virtual meals for a character in a video game. Option may be utilized to utilize the meal against the character in the video game (e.g., to increase the health and/or stamina of the video game character). Persons skilled in the art will appreciate that an NFT may have a set number of times the NFT may be utilized. For example, suppose an NFT represents a carton of dozen eggs. A user may determine to use (e.g., in the case of the game use may be eat) an egg. After all twelve of the eggs have been used, the NFT may be autonomously destroyed. Alternatively, for example, the NFT may be a carton that can hold up to a pre-determined number of objects (e.g., twelve eggs) and the carton could be utilized to store eggs as eggs are gathered in the game. A user may then sell the NFT in different states (e.g., with no eggs in the carton, with a partial number of eggs in the carton, or with the maximum number of eggs in the carton).

Option 174 may be utilized to provide high security storage for one or more NFTs such as one or more NFTs selected by a user. A high security storage may be, for example, an additional level of storage and may be associated with an additional cost. For example, a platform may include off-site storage and may provide a consumer with various types of off-site storage and options, each associated with a different cost, so a consumer can select a type of storage product desirable by the consumer. Persons skilled in the art will appreciate that a consumer may pay for additional costs through the system using pre-stored or manually entered payment options (e.g., credit card, debit card, pre-paid card, ACH, stored-value such as stored store credit). Persons skilled in the art will appreciate that option 174 may be utilized for additional NFT-related services, such as third-party services. For example, option 174 may be utilized by a user to select from a number of different insurance options associated with digital asset storage. In this manner, a platform may provide insurance options to a consumer and may generate revenue by offering these additional insurance options. For example, a user may request insurance and may be asked to provide a total insured value. The consumer may then be quoted, by one or more services, various insurance coverage plans and associated cost. The user may then select a desired type of insurance and an additional platform service fee (e.g., a fixed amount and/or a percentage of a charged amount) may be applied.

Option 175 may be utilized to enable dual-factor authentication for one or more collectibles (e.g., digital NFT collectibles). A user may be provided with a list of actions, before or after enabling a dual factor authentication for a collectible, where the dual factor authentication is to be applied such as, for example, sending trades with the NFT, exporting the NFT, placing the NFT for sale, and/or accepting and/or modifying a purchase offer or trade offer. A dual authentication may be required, for example, to disable and/or enable dual factor authentication for one or more collectibles (e.g., digital collectibles).

Option 176 may be utilized to import and NFT from and/or export an NFT to a blockchain (e.g., a blockchain selected from a list of blockchains). A platform may provide, for example, a list of blockchains and associated costs and/or processing times. An additional service fee may be charged for any import or export that may, for example, be a fixed amount and/or a percentage of particular amount (e.g., a percentage of a declared value, last sale value, and/or percentage of import/exportation cost).

Option 177 may be utilized to buy, sell, trade, and/or perform any other action on an NFT (e.g., donate an NFT to charity). Any option may be provided as multiple options. Accordingly, option 177 may be provided as a different buy option, sell option, trade option, donate to charity option, etc. Persons skilled in the art will appreciate that multiple copies of the same collectible may be for sale and a user may select an option to find additional copies of the same collectible to purchase. Persons skilled in the art will appreciate that multiple sales platforms may be provided so that a user may select a sales platform. For example, a user may select to list a collectible for sale on a platform (e.g., platform providing interface 150) or a different platform (e.g., a third-party platform not providing interface 150). Additional options may be, for example, an option to list a collectible for auction. A user may be provided with a list of auction platforms that can be utilized and the user may select a auction platform to list the collectible for auction.

Option 178 may be included to lock and/or unlock a feature of a platform associated with an NFT or a feature of the NFT itself. For example, a user may lock and/or unlock an NFT so that the NFT cannot be viewable on a platform by third parties. A locking and unlocking feature, may be utilized, for example, for trading, selling, selling and/or utilizing a feature of an NFT or utilizing an NFT itself.

Option 179 may be utilized to add one or more personal flags to a collectible such as a digital NFT collectible. Different types of personal flags may be provided and different descriptors may be added for the different flags. Different flags may take different forms (e.g. different indicia and/or different colors). Accordingly, for example, a user may use one flag to list the items the user is looking to trade and another flag the user is looking to keep for a long-term collection.

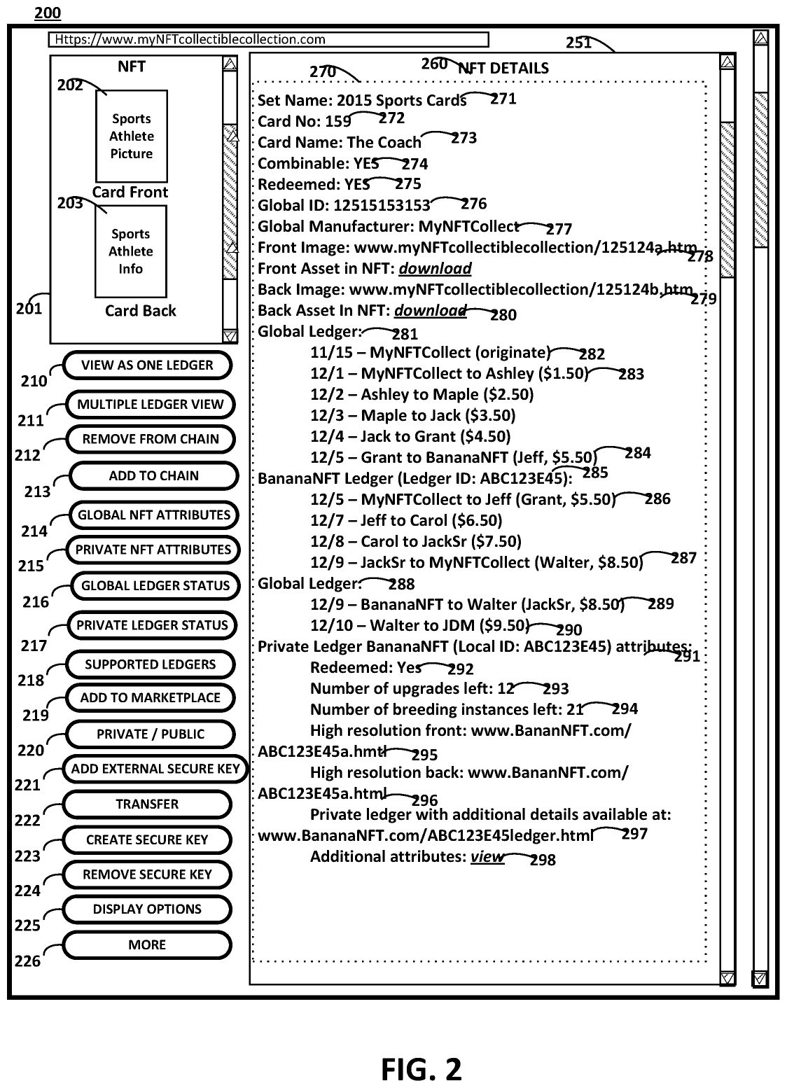

FIG. 2 may include graphical user interface which may include, for example, interactive window and interactive window 251. Graphical user interface 251 may be, for example, a graphical user interface providing details and features for a collectible such as a digital NFT collectible. Interactive window 201 may, for example, include media content associated with an NFT such as media 202 and media 203. Media 202 and 203 may include, for example, images, videos, and/or audio.

Graphical user interface 251 may include NFT details 260 that may include NFT attributes 270. Attributes 270 may include, for example, data stored in an NFT smart contract. Attributes 270 may include, for example, any number of a set name, set yet, card number, card name, multi-state value associated with combinability (e.g., YES or NO), multi-state value associated with redeemability (e.g., YES or NO), a global identification number (e.g., a unique global token), a global collectible manufacturer name, a first media (e.g., an image), a first media location (e.g., web address), a second media (e.g., an image), a second media location, a global ledger, a private ledger, and/or private ledger attributes.

Persons skilled in the art will appreciate that a digital collectible, such as a digital NFT collectible, may be a multiple ledger NFT. A NFT (e.g., a smart NFT contract) may include data structures for additional legers such as private ledgers. Accordingly, for example, an NFT may be transacted on a public ledger (e.g., Ethereum) and public ledger functions may be performed on the public ledger (e.g., Ethereum) while the NFT may be transferred to a second ledger (e.g., a private ledger) and transactional information associated with transactions in the second ledger may be stored in the NFT.

Persons skilled in the art will appreciate that different ledgers may have information generated from each platform and utilized by each platform. Accordingly, a NFT, such as a digital collectible NFT, may have data that it utilized by only by a specific ledger or data may be utilized by multiple ledgers. An NFT may have, for example, NFT attributes 270. An NFT may be created, for example, on a global public ledger. A data structure (e.g., a smart NFT contract) may store information, for example, in addition to the ledger. In doing so, the transaction history for an NFT may be viewable through both an NFT and viewing details about the NFT on a ledger. A multiple ledger digital NFT collectible, for example, may include multiple unique identification numbers. For example, an NFT may include global unique identification number 276 which may be issued serially or non-serially as a numeric and/or alphanumeric token. Similarly, a multiple ledger digital NFT collectible may have a unique identification number for each ledger such as ledger identification number 285, which may be a numeric or alphanumeric unique identifier issued serially or non-serially. A platform may have the ability to create a limited or unlimited number of ledger data structures in an NFT so that any number of ledgers may be identified and include ledger-specific attributes such as, for example, ledger-specific unique identifiers. Persons skilled in the art will appreciate that a single unique identifier may alternatively be used and such a unique identifier may be utilized by additional ledgers to identify the digital asset such as a digital collectible asset.

Digital asset attributes may include grouping name 271 which may be, for example, the set name and/or subset name of a digital collectible set such as a digital sports collectible set. A collectible number, such as a card number may be included as collectible number 159. Persons skilled in the art will appreciate that multiple copies may be manufactured for a particular collectible number. The number of copies (e.g., the print run) of a digital collectible may also be included as an attribute. An asset name, such as a collectible name, may be included as collectible name 273. Persons skilled in the art will appreciate that an NFT may have particular multiple-state features. For example, a digital collectible may be combinable with another digital collectible (e.g., a qualifying digital collectible) and the status of the feature may be included. For example, a collectible may be combinable with another collectible to form a new collectible. Attributes may be associated with a collectible to identify if a collectible has a particular feature. Accordingly, for example, collectible feature attribute 274 may be included. Persons skilled in the art will appreciate that a digital collectible may include attributes showing whether or not a collectible can be utilized with a feature and/or if the collectible has been utilized with a particular feature. Accordingly, an attribute may be provided as an attribute to identify a collectible has both a feature as well as the state of the feature. For example, attribute 275 may be included to not only notify that a feature is useable with a collectible but also if that feature has been utilized. For example, a collectible may be redeemed in a one-time use redemption. A redemption of a collectible may require a list of qualifications be met such as, for example, co-redemption of a list of particular collectibles (e.g., a collectible set). In providing a redemption capability, a collectible may have different value before and after the collectible is redeemed. Accordingly, a collectible does not need to be destroyed to perform a function (e.g., redeemed to earn a collectible achievement/reward). Accordingly, multiple-state attribute 275 may be utilized to display to a user the state of a particular attribute (e.g., redeemed, unredeemed, redeemed 2 times of a total of 4 total permitted redemptions).

Persons skilled in the art will appreciate that attributes and fields may be constructed such that they may never be changed by any party after origination (e.g., publication to a public ledger) or only a particular entity or entities may change particular variables. For example, a collectible manufacturer may be able to change certain attributes (e.g., multi-state attribute 275) but not other attributes (e.g., unique global identifier 275). The name of a collectible manufacturer may be included in the NFT as NFT manufacturer 277. Each NFT manufacturer may be unique identifiable on a particular platform (e.g., a public blockchain) and each NFT manufacturer may be provided with software to assist in creating and publishing the NFT to a platform (e.g., a public platform) to ensure that only a specific manufacturer can produce digital assets that are attributable as coming from that specific manufacturer. In doing so, for example, the specific manufacturer name may be utilized to determine the authenticity that a digital collectible was produced by that specific manufacturer.

A digital collectible may include media content stored in the digital collectible itself and/or links to the media content. Media content may be located on a remote server, set of remote servers for a single platform, or system of remote servers such as a global system of third-party remote servers. Persons skilled in the art will appreciate that the more servers utilized to support a media link, the more catastrophic situations the media link may survive. Persons skilled in the art will appreciate that placing the media as a data structure on the digital collectible itself (e.g., along with instructions on how to view the media), the survivability and persistence of the media content may survive catastrophic events that are not survivable through location links (e.g., internet website links and/or public/private platform links). For example, media link 278 may be included as well as content extractable from the digital collectible. A digital asset may include any number of digital media such as two or more than two. Accordingly, for example, media link 279 may be provided as well as extractable media 280. Persons skilled in the art will appreciate that media link 279 may store the same media as extractable media 280 or a different version of the media (e.g., different quality such as different resolution). Accordingly, for example, a platform may receive a digital collectible such as an NFT and may utilize a link to provide a media while preserving a different version of the media (e.g., a higher quality version) for the owner of the collectible. Persons skilled in the art will appreciate that a ledger (e.g., a ledger of a public blockchain) may include the media content links such that viewers of the ledger may select a unique identifier and also be able to retrieve links to media associated with the digital collectible. Persons skilled in the art will appreciate that a digital asset may include any type of content (e.g., a financial record or data record) and that links to any content as well as the content itself may be associated with a digital asset as a content retrievable link and/or content itself.

Persons skilled in the art will appreciate that digital content of a digital asset such as collectible media may be encrypted so that only the owner of the collectible media can retrieve, for example, stored content. Accordingly, a low-resolution quality media may be provided on an accessible link and a high-resolution quality media may be provided in the digital asset itself. Person skilled in the art will appreciate that a public blockchain may permit third party processors (e.g., miners) to view all data in digital asset (e.g., NFT collectible). Accordingly, for example, a second security token may be issued (e.g., that is on a blockchain or not on a blockchain) and this second security token may be required to unlock (e.g., decrypt) media content or other asset data). In doing so, a person that gains access to a digital asset may not have access to a security token needed to discern a part of the information on the digital asset. As per another example, a security token generating algorithm may be included in a digital asset. A digital asset (e.g., a digital collectible) may be set so that it requires one of these security tokens to be utilized to gain access (e.g., read-only access and/or read/write access) to an attribute such as a media content). For example, a generate digital security token may be processed by one third party processor and the digital collectible may be constructed to only be able to use a security token that was generated as the second to last security token. Accordingly, an additional security token would need to be generated before the previously generated security token can be utilized. In doing so, an owner of an NFT may be able to provide an NFT to a third-party processor to generate a security token that cannot be utilized by that third party processor to access data. Accordingly, a NFT would be communicated with the last security token generated and the new user would need to generate a new token in order for the previously generated token to be able to be utilized to extract the data. A counter may be stored on an NFT and may be updated each time a security token is transacted so the NFT has information in the NFT as to the security token needed to unlock a particular part of data (e.g., all data). Persons skilled in the art will appreciate that the two tokens may be generated in a single transaction such as, for example, one token may be provided by the seller (e.g., transferor) of an NFT that was received when the seller (e.g., transferor) generated the NFT or received the NFT). The buyer (e.g., transferee) may then generate a security token for the next transaction and utilize the received security token to unlock. Two different third party processors may, for example, be required to complete a transaction. A transferor processor may be required to generate the first security token and the second processor may be required to generate the second security token. A security ledger may be provided on a security token where the security ledger is updated each time content is decrypted. In doing so, an owner may review the security ledger at any time to make sure there was no unauthorized access to the security ledger. The security ledger may be stored on a public ledger, private ledger, a single processor private ledger that is accessible to the public (e.g., via a website link), and/or any type of platform, ledger and/or blockchain.

Persons skilled in the art will appreciate that a platform may be provided that requires an identifiable user of that platform to originate and transact a digital asset such as a digital collectible. Such platform may be, for example, a public platform that uses third party processors to provide a persistent public ledger or a private platform. In doing so, for example, a ledger may be provided that provides an ownership chain for a digital asset. The platform may, for example, require that only the current owner of a digital asset be the entity that is permitted to transact the digital asset. Alternatively, for example, a platform may permit the entity in possession with the most recent transacted version of the digital asset to transact regardless if the entity in possession is the last recorded owner (e.g., the version last successfully transacted through a particular platform such as a blockchain).

Global ledger 281, may be, for example a primary or initial ledger for a digital asset such as a digital NFT collectible. Persons skilled in the art will appreciate that a digital collectible may be created (e.g., a smart NFT contract completed as well as data content for, and placed in, data structures in the NFT contract) without placing the digital collectible on a ledger. Persons skilled in the art will appreciate that no ledger is needed to transact a digital asset between multiple parties. For example, a platform may provide a digital asset transfer without, for example, keeping the history of transfers for a digital asset. For example, a entity-to-entity or person-to-person transfer platform may be required that transacts an NFT uploaded by one entity on one platform, regardless of origin of the NFT, to another entity on another platform. A fee may be charged to one or both entities for facilitating the transfer.

Global ledger 281 may be provided on a platform, such as a public blockchain platform, and/or provided in a data asset such as a digital collectible NFT. The ledger may include the date and/or times of particular types of activities. The types of activities provided on a ledger may be, for example, provided in the digital asset itself. The types of activities provided on a ledger may be, for example, defined by a platform providing the ledger and may be, for example, a set of functions (e.g., functions that may require third party processing to perform). A ledger may be a secure ledger such as a ledger provided by a public blockchain or another security methodology (e.g., physically stored in a secure facility). Persons skilled in the art will appreciate that a public blockchain processed by third-party processors may provide a different type of security and processing capabilities than other transaction processing approaches. Accordingly, for example, a public platform may be provided for a ledger that does not operate on a blockchain. As per another example, a private platform processed by known entities to the private platform may be provided (e.g., on a blockchain or another structure that may provide a ledger) that may be accessible fully or partially (e.g., digital assets and transaction history viewable) to entities identifiable on the private platform and/or entities not able to be identified on the public platform. Accordingly, one or more features may be accessible to both identifiable and non-identifiable entities (e.g., feature of viewing a asset and viewing ownership history) and other features may be accessible to only identifiable entities (e.g., creation of a digital asset such as a digital collectible or the transaction of a digital asset). A user may be identifiable, for example, through a login and password. Multiple forms of authenticiation (e.g., two-factor authentication) may be utilized to perform any function or a particular type of function (e.g., in order to transact a digital asset).

A ledger, such as a global public ledger, may include an origination such as origination entry 282. An origination may include placing the entire digital asset (e.g., smart contract) on a blockchain such as a public blockchain. Doing so may, for example, cause one or more functions of a smart NFT contract to be executed. The origination entry may include, for example, the origination entity (e.g., collectible manufacturer) along with additional information such as a date and time of the creation. Persons skilled in the art will appreciate that a note or memorandum or other entry may be added that includes a link to a website address that has additional information (e.g., a manufacturer's webpage for the digital asset that includes additional information not able to be viewed through the originating ledger (e.g., public blockchain). Persons skilled in the art will appreciate that a public blockchain may be provide in which third-party blockchain processors each retain and publish a copy of the blockchain ledger such that the ledger persists so long as, for example, a third party blockchain processor persists.

A ledger, such as a public ledger of a public blockchain, may include transactions between multiple entities. Each entity may, for example, be identifiable to the ledger platform. And, the ledger platform may be required to be utilized to deliver the transaction in order to, for example, record the transaction. Accordingly, for example, an entity that manufactures a digital asset (e.g., digital NFT collectible) may transact to a user (e.g., manufacturer to third party entity transaction 283). Such a transaction may occur, for example, after the digital collectible is actually sold to a user and when, for example, a digital collectible is opened up from a host package (e.g., a pack of NFT collectibles). Persons skilled in the art will appreciate that a host package (e.g., a pack) may create NFTs when it is opened using rules and content included in the pack (e.g., and create NFTs in the manufacturing name of the entity that opened the pack).

A transaction may also be associated with, for example, a sales price, a purchase price, one or more transaction fees, one or more taxes, and/or any other attribute (e.g., a purchaser inputted memo and/or a seller inputted memo). For example, transaction record 283 may include a price in the record (e.g., $1.50) which may be, for example, the price paid for the item by the purchaser. If an item were purchased from a hosting package, the price paid for the hosting package may be divided by the number of items in the hosting package. For example, suppose a user purchases a pack of 4 digital NFT collectibles for $6, then the user may be transferred the 4 digital NFT collectibles upon opening the pack at a price of $1.50 per NFT collectible.

Persons skilled in the art will appreciate that a ledger platform (e.g., a private and/or public blockchain platform) may be provided with different types of users. For example, a type of user may be a third-party processor that processes transactions in exchange for a transaction fee. A user may be an end user that may, for example, originate/make digital assets as well as transact digital assets. A user may also be a blockchain with its own users (either identifiable or not identifiable to the originating platform such as the originating blockchain) and its own ledger platform. Accordingly, a public blockchain may recognize a private blockchain and permit the private blockchain to update the primary ledger or a secondary ledger (e.g., a private ledger) so long as any transaction to a user or blockchain outside of the private platform receives a digital asset from the private blockchain. Accordingly, for example, a user may have the name “banananFT” and may be a private (or public) blockchain ledger separate form the originating ledger (e.g., originating ledger of a public blockchain). Persons skilled in the art will appreciate that the public ledger may alternatively be constructed where any user may deploy, at any time, a private ledger (e.g., and keep the private ledger in a pre-determined area of a digital asset (e.g., a smart NFT contract). Accordingly, private ledger entry 285 may be included to note the asset was moved to a private ledger. A private ledger may, for example, have its own unique ledger identification. A dual entry may be provided to show the transition from one ledger to another. For example, entry 284 may be utilized to show entry into BananNFT and ledger entry may be utilized to show entry from MyNFTCollect. Users on the two ledgers may be identifiable to each other or may be identifiable to just the separate ledgers (e.g. user Jeff of MyNFTCollect and BananaNFT or as user Jeff to MyNFTCollect and BananaNFT.Jeff where BananaNFT.jeff is or is not known to MyNFTCollect). Furthermore, for example, users from different platforms may not be identifiable and transaction histories may just show, for example, the transaction from one blockchain to a different blockchain. Additional ledgers may be written to additional data structures, may be included in digital assets (e.g., digital collectibles), and may include transactions data provided from the additional ledger. The additional ledger may update data on a digital asset, such as a digital NFT collectible, after every transaction or when an asset is being moved out of a platform. In doing so, for example, the processing associated with updating data on an NFT may be minimized. An NFT may include one or more additional website links additional webpages that may provide website access to additional ledgers. In doing so, for example, ledgers may be utilized that do not require updating the NFT with additional transaction data at each transaction and/or at each export from a ledger platform to another, albeit such updates may be provided in addition to an additional ledger website link.

Entry 287 may be included when, for example, a transaction occurs from a user ledger platform to a user of another ledger platform. For example, BananaNFT ledger may transact to a user of global ledger 288. Entry 289 may be a ledger entry for a global ledger providing ownership to a user of a global ledger. Persons skilled in the art will appreciate that a digital asset structure may be provided where ledgers are provided with address names and users of each ledger are provided sub-address names. Accordingly, for example, BananaNFT.JackSr may transact to MyNFTCollect.Walter in a single entry instead of, for example, two entries. Persons skilled in the art will also appreciate that a ledger may be provided at an entity without the need for any identified users. For example, OrangeNFT may not identify any users and may transact a digital collectible. When a user wants to export to another platform (e.g., a public blockchain), both the importing and exporting may be performed by OrangeNFT without any additional information. In doing so, a private platform may hide transactions from other platforms in order to, for example, provide security and experience benefits. Additionally, for example, a platform may provide ownership data in a memo field. Accordingly, suppose OrangeNFT had a user Jeff that was selling an item through a public blockchain to a user of that public blockchain, the entity transacting may be OrangeNFT (e.g., the public blockchain identifiable user) and the user “Jeff” in OrangeNFT may be written as a memo or note for the transaction out of OrnageNFT.

Persons skilled in the art will appreciate that some users of a platform may request and/or pay an additional fee for providing a transaction between two users of a private platform on a public blockchain. Accordingly, an owner of a digital collectible may determine if the owner wants to transfer on a one particular ledger, another particular ledger, or more than one ledger (e.g., initiate a series of transactions updating the owner of the digital asset on multiple ledgers).

Persons skilled in the art will appreciate that additional platforms may have additional functions and users may, for example, desire to transfer a item such as a digital NFT collectible to a platform to obtain the benefit of such additional features. Private ledger attributes may be provided, for example, in a digital asset (e.g., digital NFT smart contract) so platforms may update platform data that is only accessible by that platform. Accordingly, a platform may have, for example, multi-state variable 292 that may only be changed by the private ledger itself and/or a user of the private ledger. Certain fields may be updated by a user of the private ledger (e.g., a transaction note) while other fields may only be updated by the ledger platform itself. Multiple state variables 293 and 294 may be another field that is only updatable by the platform identified as being able to update the field. Accordingly, an item may have a private platform redemption capability, upgrade capability, and other capabilities (e.g., breeding capabilities). Multiple platforms may then add functionality on top of a digital collectible by adding multi-state variables and building value-added features around these multiple state variables.

Persons skilled in the art will appreciate that a digital asset may have the ability to add new fields for new ledgers when they are identified to the digital asset (e.g., via a ledger function requesting an extension of an NFT to add a new field). Additionally and/or alternatively, for example, a pre-determined number of fields (e.g., fields associated with new ledgers) may be accessible and assignable as new ledgers are introduced to a digital asset (e.g., new ledgers are utilized to transact a digital asset).

Additional media content may be associated with a particular ledger and may be viewable, for example, on all ledgers or a portion of the ledgers such as media 295 and media 296. A ledge may also include a link, such as a website link, to a ledger accessible on the internet (by identified users to a platform or any users accessing the internet) so that a ledger activity does not have to be performed (e.g., a public ledger activity) in order to update a ledger that is accessible to, for example, internet users. Additional attributes 298 may be included for additional attributes.

Option 210 may be provided so that a user may view ledger data associated with a multiple ledger digital asset data as a single ledger.

Option 211 may be provided so that a user may, for example, view ledger data associated with a multiple ledger digital asset as multiple ledgers. Presentation of ledger data between option 210 and 211 may be different. For example. Option 210 may not identify ledger transitions while option 211 may identify ledger transitions (or may identify the transitions in a different manner).

Option 212 may be utilized to remove an NFT from a chain in order, for example, so the NFT can be physically transacted (e.g., physically handed) to another user. This will permit the receiving user to then utilize an option (e.g., option 213) to add an item back to a chain. In doing so, a platform (e.g., a blockchain) may be identified that the last user has permitted transactions to be made that are not recorded on the blockchain and that any user—not just the last user on the blockchain for an item)—that has possession of an item may successfully become owner on the platform (e.g., public blockchain) of an item. In doing so, additional security benefits may be provided by permitting a blockchain to be broken at the request of an owner of an item and then re-instituted by a future owner without verifying the ownership chain between the two owners. As such, a blockchain may include a feature of permitting an item to leave and return to a blockchain with a different owner.

Option 214 may be utilized by a user to view, for example, global attributes of an item and option may be utilized to view private attribute s of an item. Option 216 may be utilized by a user to view global ledger status (e.g., uptime, number of processors, transaction time, cots) while option 217 may be utilized to view private ledger status (e.g., uptime, number of processors, transaction time, costs).

Option 218 may include a list of supported ledgers for a platform or a particular digital asset (e.g., digital NFT collectible). Persons skilled in the art will appreciate that different digital assets may have structures partially or fully supported by different platforms. For example, specific features may only be supported by platforms that support those specific features and these feature supports may be provided in option 218.

Option 219 may be utilized to add an NFT to one or more marketplaces. Persons skilled in the art will appreciate that option 219 may cause an NFT to be listed on multiple marketplaces. A user may utilize option 219 to also enter in additional information such as auction information (e.g., starting bid) or selling information (e.g., sales price and accepted method of payments).

Option 220 may be utilized, for example, to change fields from being publicly viewable to private to the consumer (or a group of consumers). For example, a user may not want to show a platform that the user owns a digital collectible may be utilize such a function to do so). Persons skilled in the art will appreciate that a person that desires to keep ownership private may have the name of owner of a collectible changed to a name that is not identifiable to the user (e.g., “anonymous” or “private owner”). Accordingly, a

Option 221 may be utilized to add an external security key to unlock data in a digital asset not accessible without an external security key.

Option 222 may be utilized to transfer ownership of a digital asset to a user.

Option 223 may be utilized to create a secure key to encrypt a portion of data that can only be unencrypted using that secure key. A secure key can be removed, for example, if the user is in possession of the secure key in step 224.

Option 225 may be utilized to change display options. For example, a user may change a display option to from automatically showing media content for each digital collectible to not showing media content for each digital collectible.

Option 226 may be utilized, for example, to view additional options such as additional features that may be utilized, viewing comparable digital assets on one or more platforms (e.g., other copies of the same digital collectible number of the same digital collectible set if other copies exist and are viewable).

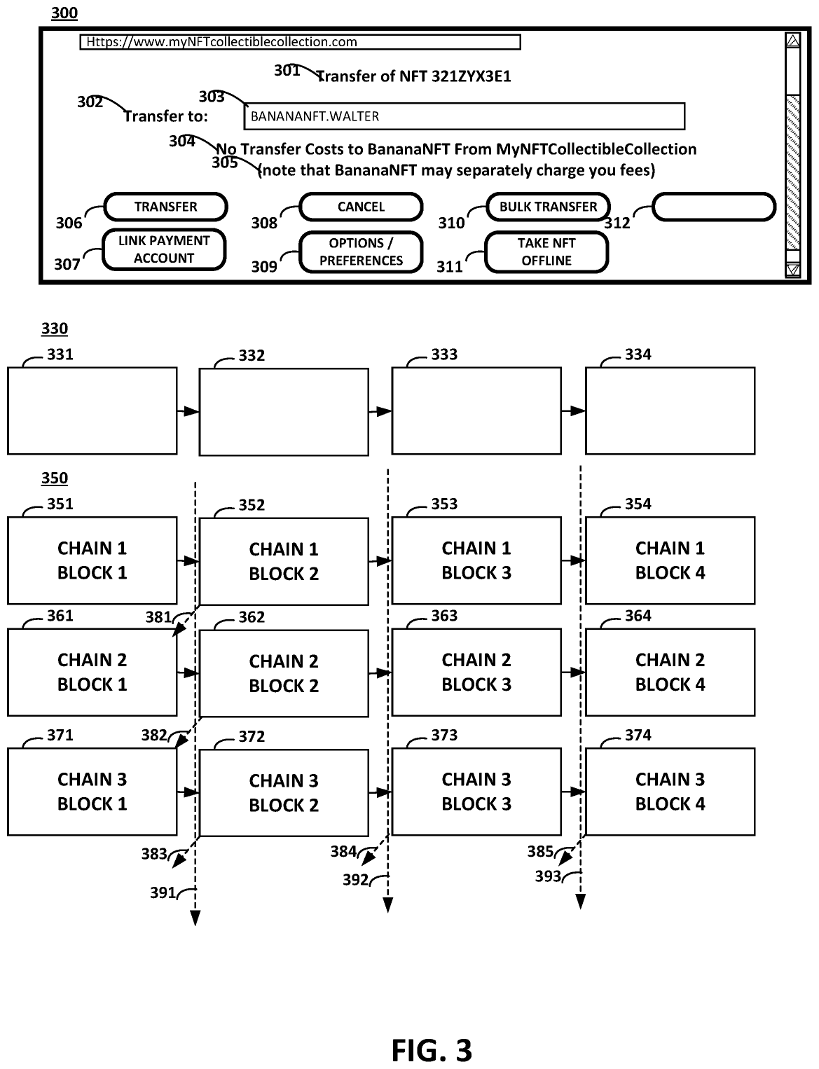

FIG. 3 shows user interface 300 that may include information 301, manual input window 303, indicia 202-205, and options 306-312. Persons skilled in the art will appreciate that a ledger and user identifier may be required, for example, to transfer an NFT from one entity to another entity. A platform (e.g., a public blockchain) may be determined through one user interface input (e.g., a list of transaction platforms) and a user may be determined through another user interface input (e.g., an input box). Persons skilled in the art will appreciate that a platform (e.g., a platform providing interface 300) may include an address book and may provide a user with the ability to save addresses (e.g., of NFT wallets able to and and/or receive NFTs) and retrieve the addresses, for example, at the direction of a user. Description 301 may be displayed to provide a description of an action being performed and a digital asset (e.g., digital NFT collectible) associated with that action. Accordingly, for example, a user may select an NFT (e.g., NFT with unique identifier “321ZYX3E1”) for transfer and transfer the NFT to the user address provided in input 303. Descriptor 302 may be provided, for example, to indicate the type of information for manual input box 303. Descriptor 304 may be utilized to provide additional information on the transfer such as the platform names and/or user entities as well as any transfer cost (e.g., by one or more platforms if more than one platform utilized). Option 306 may be utilized, for example, to initiate a transfer. Persons skilled in the art will appreciate that, for example, a multiple factor authentication process may be utilized such that initiating option 306 may cause an authentication (e.g., a one-time password be entered that was provided to a user's email and/or phone number). One or more payment accounts may be linked using option 306, retrieved using option 306, and/or used to pay for an action (e.g., transfer). A transaction may be cancelled before it is completed utilizing option 306. Additional payment and/or transfer options (e.g., adding a transaction memo/note) may be provided in option 309. A bulk transfer option of transferring multiple digital assets may be deployed utilizing, for example, option 310. Each digital asset in a bulk transfer may be autonomously transferred serially or autonomously transferred in parallel and different items in a bulk transfer may transfer across a different ledger (e.g., public blockchain). An NFT may be taken offline in step 311 so that the NFT may be downloaded and stored in without the knowledge of any platform as to the location of storage. An NFT may then be added online by the consumer that removed the NFT (e.g., utilizing option 311). Persons skilled in the art will appreciate that an NFT blockchain chain may also be broken using an option so that the ownership chain does not show a continuous set of owners and a blockchain may be provided with the option for a consumer that owns an item (e.g., digital NFT collectible) to designate that an owner outside of an ownership chain on the public ledger can take ownership of the NFT if the entity has, for example, possession of the NFT. Additional security may be added such as a transfer code an the transfer code may need to be entered and processed on the blockchain for ownership to transfer to the out-of-chain owner. Such a transfer code may, for example, be provided to an owner of an item at the time the owner requests a function to take the asset off a blockchain (e.g., break the chain of ownership). The transfer key may be transferred encrypted and decrypted by the requesting owner and the decrypted key may be provided with the item to another owner (who may be required to use the key to add the digital asset to the ledger and continue the ownership chain from that user).

A ledger may be processed by, for example, a blockchain such as a public blockchain. Blockchain 300 may, for example, be utilized. Block 331 may include, for example one or more transactions using digital NFT assets such as digital NFT collectibles. Multiple third-party processors may process data block 331. The third-party processor that correctly processes data block 331 may, for example, receive transaction fees associated with data block 331. Data block 332 may then be initiated for processing (e.g., by third party processors). Persons skilled in the art will appreciate that data block 332 may not be processed until data block 331 is processed and information from processed data block 331 may be required to process data block 332. Accordingly, a chain of data blocks may be provided where a data block cannot be processed until the previous data block is correctly processed (e.g., according to rules associated with the blockchain). In this manner, data block 333 can be processed after data block 332 is processed and data block 334 can be processed after data block 333 is processed.

Multiple chain blockchain 350 may be provided for processing transactions (e.g., NFT collectible ownership transactions between entities such as between a transferor and transferee). Multiple chain blockchain 350 may include, for example, multiple chains that are each processed by a different set of processors (e.g., third party processors). Each chain may have a limit to the maximum and/or minimum number of processors (e.g., more than 50 but less than 100). Whenever a chain fills with processors, a new chain may be created for new processors. Accordingly, such a blockchain may be able to scale up and scale down with the number of third-party processors. A third party processor may be permitted to process a data block in one chain or a data block in multiple chains. A multiple chain blockchain may be provided in a number of ways. For example, all parallel blocks in a chain (e.g., all block 1s) in each chain may need to be successfully processed before the next block in all chains occur. Accordingly, for example, processors that complete processing block 351 may not be able to move to block 352 until blocks 361 and 371 are also processed. Processors may, if a block in their chain is completed, begin processing of blocks in other chains instead of remaining, for example, idle waiting for the processors to complete. Each block in a chain may utilize data from one, more than one, or all successfully processed blocks in the previous chain in their processing. For example, processing block 352 may require information from successfully processed block 351, 361, and 371 to successfully process. In doing so, for example, third party processors may be required to processes all blocks in all chains in order to have the information needed to process the current block that is being processed in each chain. Accordingly, a multiple chain blockchain is provided.

In this manner, blockchain 350 may require all blocks before portion 391 to be processed before the blocks between portion 391 and 392 may be processed and before blocks between 393 and 392 may be processed.

Persons skilled in the art will appreciate that each data block in a chain may be randomly assigned the block from which data is needed. Accordingly, for example data block 352 may require data from block 361 using requirements 381 and this may be assigned (e.g., through a function) as a after the required or all blocks in a stage (e.g., blocks before stage 391) are complete. Accordingly, for example, all bock 2s in all chains may be assigned a predecessor block only after all block is in all chains are complete. Alternatively, for example, a block in a chain may identify the chain and block after it is processed that require data from that processing so that processing for the identified block can be immediately started. Persons skilled in the art will appreciate that processing may generate a number and the last digit (or set of digits) of the number that is not a block under processing may be utilized as the next block. Persons skilled in the art will appreciate that a verification function may verify that no digital items were transferred in separate blocks in separate chains during a staging period. For example, a verification algorithm may cancel any transfer of an item already transferred in a stage of blocks of a multiple chain blockchain. Accordingly, suppose a stage is provided by staging lines 392 and 393. Suppose block 363 completes first and transfers item A and then block 353 complete second and also transfers item A. A verification process may permit the first transfer of a unique item (i.e., item A on block 363) and not the second transfer of that unique item (i.e., item A on block 353).

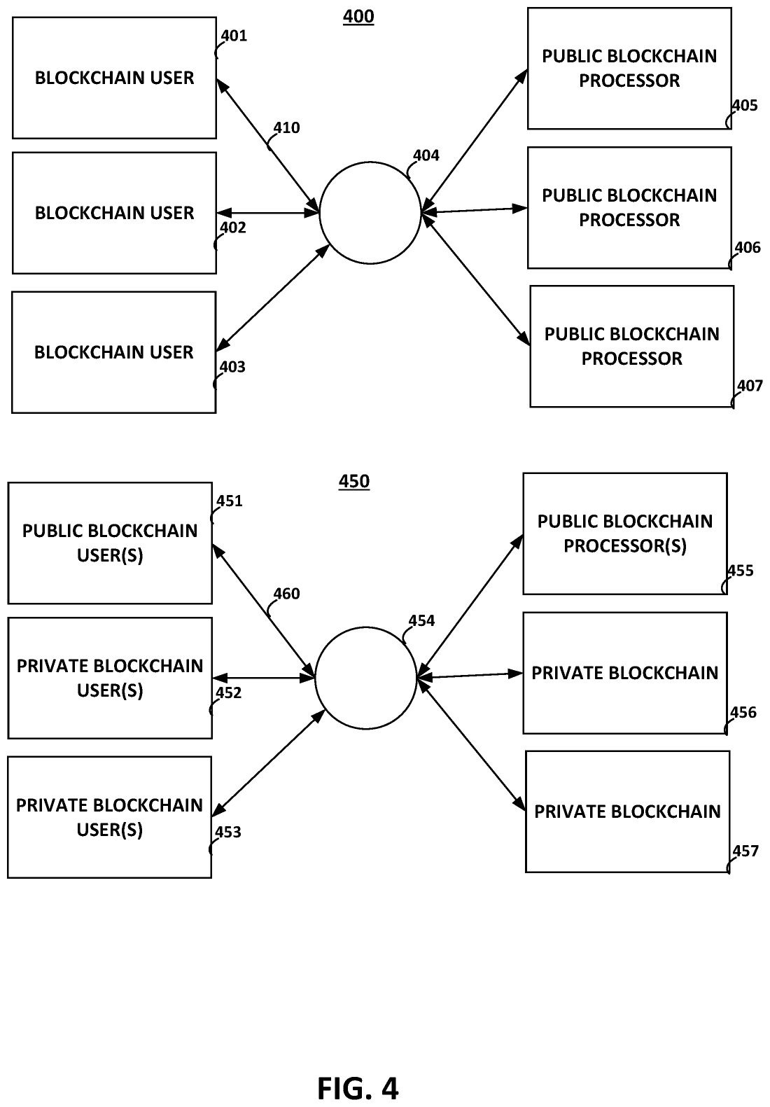

FIG. 4 shows topology 400 that may include blockchain users 401-403 performing blockchain transactions (e.g., smart NFT contract functions processed on a blockchain) utilizing public blockchain processors 407 across telecommunications network 404. Persons skilled in the art will appreciate that users 401-403 may transfer ownership of a digital asset (e.g., a digital NFT collectible) between each other utilizing a blockchain processed by processors 405-407. Upon successful completion of processing a transaction, each of processors 405-407 may have a record, such as a publicly accessible record, of the transaction as well as all prior records in the blockchain. A new processor that desires to process data blocks that may include transactions may be required to process all transactions in the chain since the origination of the chain so that, for example, the processor includes information required to process the next block of data.

FIG. 4 shows topology 450 that may include blockchain users 451-453 communicating through network (e.g., an intranet or internet). Communications may include, for example, performing NFT smart contract functions performed by blockchain processors. Communications may include, for example, creating a digital asset (e.g., a digital NFT collectible) and transacting the digital asset for a monetary value or a non-monetary value (e.g., another digital asset). Accordingly, users may utilize various platforms (e.g., public blockchain) to purchase digital assets, sell digital assets, donate digital assets, and/or trade one or more digital assets for one or more other digital assets. Persons skilled in the art will appreciate that an interface may be provided such that a user may offer a trade to another user. A trade may have any number of digital assets. For example, one user may offer another user two digital assets (e.g., digital NFT collectibles) in exchange for four digital assets (e.g., two digital assets that are not NFT collectibles and two digital assets that are NFT collectibles). The user receiving the trade may be provided with an option to counter (e.g., change the digital assets in the trade, add a monetary value as part of the transaction, etc.). A receiving user of a trade or a countered trade may accept the trade and then, for example, verify the acceptance (e.g., as well as perform a second factor authentication). A platform may then, for example, privately platform lock each collectible in the trade so that the user cannot perform any action on the collectible while the trade is completing. During this time, for example, the platform may, for example, complete an individual transaction for each individual asset in the trade until all asset transactions are completed (e.g., at which time the platform may platform unlock each digital asset so that the new owner can start performing activities using the assets). In doing so, a trading platform may be provided that enables large volume multiple sided transactions of digital asset trades using, for example, a public or private blockchain. Persons skilled in the art will appreciate that a transaction may include digital assets on several platforms and completing a transaction may include performing separate transactions (e.g., serially or in parallel) across the various different platforms. A completed transaction (e.g., digital asset trade and/or digital asset purchase/sale) may include providing each user with a communication (e.g., email, text, and/or interface update) of the transaction completion. Topology 450 may include, for example, one or more public blockchain processors 455. Persons skilled in the art will appreciate that public blockchain processors 455 may each provide a publicly accessible ledger of all successfully completed transactions performed on the blockchain that may be, for example, indexable and searchable through, for example, additional third-party platforms. Topology 450 may include any number of private blockchains 456 and 457 that may be, for example, a private instance of a public blockchain that is processed by private one or more private processors. Persons skilled in the art will appreciate that a private blockchain may publish all or a portion of its ledger to, for example, users identifiable to the private blockchain (e.g., via a login/password) as well as any entity accessing a publicly accessibly webpage of the private blockchain. Persons skilled in the art will appreciate that the private blockchain may store assets on third party and publicly accessible storage devices. For example, the pictures of digital collectibles may be stored, for example, on a third-party peer-to-peer storage system (e.g., Interplanetary File System).

Persons skilled in the art will appreciate that a digital asset may be, for example, data that represents knowledge. Putting such digital assets on a public blockchain may, for example, attempt to permanently keep that knowledge public and unmodifiable. For example, a social media system is provided where each public message is stored on a public blockchain for anyone to view (e.g., users of the media platform that desire to view public messages from a particular user). Accordingly, free speech may be protected by putting the free speed on a public blockchain such as a multiple-chain public blockchain that may include, for example, improved cost, processing time, and environmental impact over a single chain blockchain. Such knowledge may be, for example, transacted (e.g., traded and purchased/sold) and may be encrypted (e.g., via a private key that is managed by a platform that utilizes a public blockchain) or may be unencrypted. Persons skilled in the art will appreciate that such a media platform may not be configured to provide deletion (e.g., or may be configured to permit deletion) such that content on the blockchain (e.g., created through the origination of an NFT with the knowledge) may persist as long as the blockchain persists (e.g., as long as a third party blockchain processor continues to process the blockchain and have a copy of the data of the chain publicly accessible). Accordingly, for example, a public figure may post a message on the blockchain social media platform and that message may not be able to be deleted by anyone at any time as the message is stored, for example, on a public blockchain.

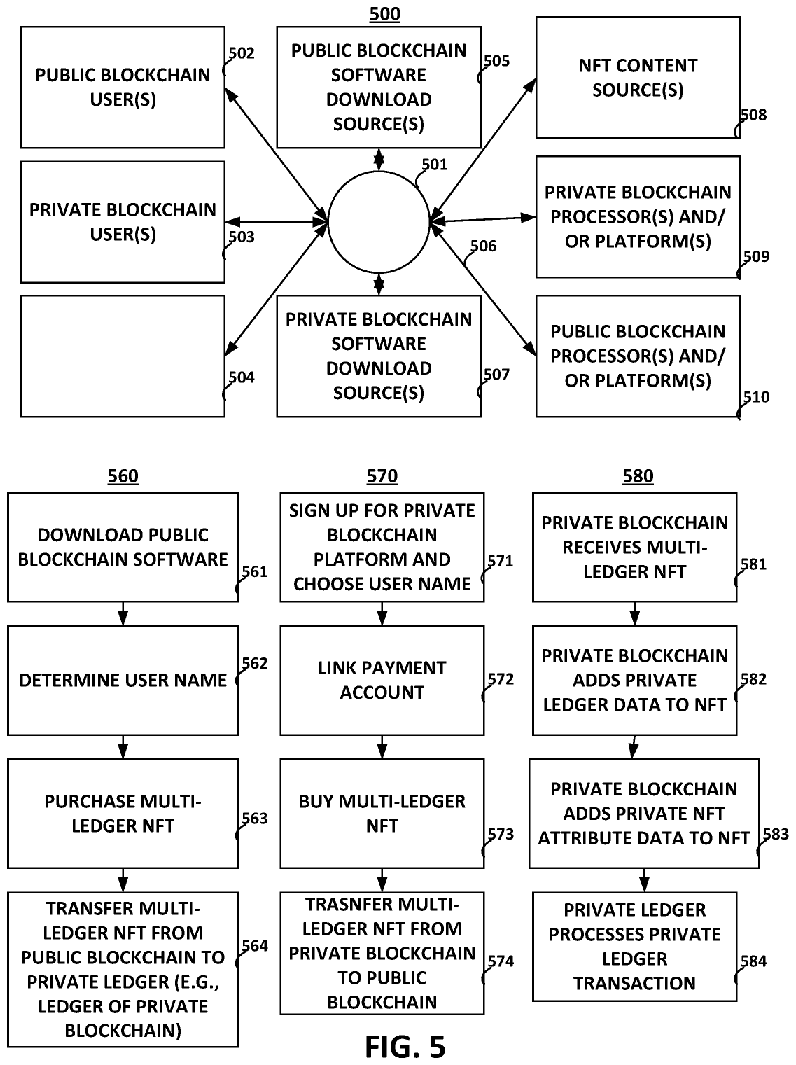

FIG. 5 shows topology 500 that may include one or more public blockchain users 502, private blockchain users 503, additional systems 504, public blockchain software download source(s) 505, private blockchain software download source(s) 507, NFT content source(s) 508, private blockchain processor(s) and/or platform(s) 509, public blockchain processor(s) and/or platform(s) 510, and any number of communication mediums 506 such as communication networks and communication signals 506. Communication signals 506 may be, for example, wire-based signals and/or wireless signals. Additional structures 504 may, be for example, layer 2 providers that may provide data processes to perform actions on the input/output between processes of topology 500 so that multiple processes may be utilized together in an improved manner (e.g., improved cost, processing speed, and/or environmental impact).

Flowchart 560 may be provided and may include step 560 in which public blockchain software is downloaded. Persons skilled in the art will appreciate that public blockchain software may be downloaded from one or more sites hosting the public blockchain software. An authority over the public blockchain (e.g., an entity that originally created the blockchain or manages a monetary system of the blockchain) may also have a blockchain software available for download or to perform a check to make sure software has not been modified. Blockchain software may be, for example, open source so that entities can modify the software to add functionality. Persons skilled in the art will appreciate that different types of software may be downloaded and installed by different types of entities in a blockchain (e.g., users and/or content manufacturers and/or supplemental ledgers and/or blockchain processors). Alternatively, for example, the same software may be downloaded for different types of transacting entities on a blockchain (e.g., users and/or content manufacturers and/or supplemental ledgers and/or blockchain processors) and the entities may utilize features on the software associated with the particular features being performed at any particular time.

A username may be determined by an entity in step 562. Person skilled in the art will appreciate that a user may be required to select a unique username that is not dependent on a type of entity, but is unique across, for example, all entities of a blockchain. Accordingly, for example, a registration process may be provided. User identities may be stored, for example, in ledger data or in other database data and the username may be compared against all properly registered (and/or active) user names. Persons skilled in the art will appreciate that a platform may not utilize a blockchain and may, for example, utilize a series of storage devices, database devices, and computing devices (e.g., servers) and any information that may be stored on a blockchain may, for example, be stored across the devices of the platform and/or accessible to the platform. After, for example, a user is registered on a platform, such as a multiple-ledger blockchain or a platform that has multiple-ledger digital assets such as multiple-ledger NFTs, the user may purchase a multiple-ledger NFT in step 563. A multi-ledger NFT may be transferred (e.g., traded, donated, sold, purchased) from a user through a public blockchain to a private ledger (e.g., a private ledger of a private blockchain) in step 564. Persons skilled in the art will appreciate that a private blockchain may be a private instance of a public blockchain or may be an instance of a different blockchain (e.g., a public blockchain may be a single chain blockchain utilizing one processing algorithm and a private blockchain may be a multiple chain blockchain utilizing a different processing algorithm).

Flowchart 570 may also be provided and may include step 571 in which a user may be provided with a sign-up interface for creating a unique user name on a private platform (e.g., a private blockchain platform or a private non-blockchain platform). Persons skilled in the art will appreciate that a private platform may include multiple ledgers and may replicate ledger keeping across the multiple ledgers. In doing so, for example, additional security and redundancy may be provided. A payment account (e.g., payment card, bank account, gift card, etc.) may be linked in step 572 to a user's account. A transaction that requires monetary funds may be executed in step 573 such as, for example, the purchase of a multi-ledger NFT. Such a transaction may process a linked payment account and, upon verification that payment has been authorized, a transaction may be completed. Persons skilled in the art will appreciate that payments may be made, for example, to one or more platforms and the platform(s) may perform secondary transactions to provide value to users. For example, a $100 purchase of an NFT by user of platform A from a user 2 of platform B may provide $100 from platform A to platform B and platform B may be responsible for providing value back to user 2 (e.g., via the issuance of a platform credit of $100 or $100 with any transaction fee removed). Persons skilled in the art will appreciate that transactions may occur between two users of the same platform (e.g., user 1 of platform A may sell to user 3 of platform A). Persons skilled in the art will appreciate that in-platform transactions may include no transaction fee or a fee less than transactions to a user of an external platform. Furthermore, for example, a platform may directly connect two transacting users so the two users pay each other directly without the payment flowing through the platform. An additional fee may be changed, for example, for the platform and this platform fee may be delivered to the platform (e.g., via a third-party payment provider). Persons skilled in the art will appreciate that a payment process (e.g., internal or external via a third party payment processor) may utilize Know Your Customer (KYC) data and this data may be obtained from the customer through interfaces (e.g., platform interfaces) and additional information may also be communicated to a payment platform such as location/residence of each party so that, for example, any tax may be determined and charged. Persons skilled in the art will appreciate that a transaction may be, for example, a non-monetary trade where one or more digital assets are traded for other digital assets without the exchange of any monetary funds. A partial trade and monetary transaction may also occur where one or more digital assets and a monetary amount is provided to a user in exchange for one or more digital assets and/or a monetary amount. A multiple-ledger NFT may be transferred between users in, for example, step 574 (e.g., from a private blockchain ledger to a public blockchain ledger).

Persons skilled in the art will appreciate that a platform may create a digital asset such as a digital NFT collectible on a public blockchain with an identity associated with the platform. The digital asset may then be traded and transacted between users of a platform using a private ledger of that platform. At the time of export from the private platform, the original NFT may be assigned to the new owner and a platform read/write block of the NFT may be filled with the private ledger data. In doing so, an NFT may be published on a public blockchain at origination and then may be exported, albeit users have transacted that NFT without the public blockchain being updated, as the platform is exporting and the private transaction history may be preserved off platform by adding the private transaction history as a data structure to the NFT at export from the private platform.

Flowchart 580 may also be provided and may include step 581 in which ha private blockchain receives a multiple ledger NFT (e.g., from a public blockchain or another private platform). The private blockchain may add private ledger data to the NFT in step 582 (e.g., in a data structure that may be only modified by the private blockchain) and private attribute data to the NFT in step 582. Persons skilled in the art will appreciate that adding data to an NFT may be performed, for example, on the public blockchain that provided the multiple-ledger NFT and may be performed periodically (e.g., after a particular number of transactions or after particular attribute changes) or at a particular event (e.g., NFT exportation from the private platform to the original public blockchain or to another platform). Private ledger may processes a private ledger ownership transaction in step 584.

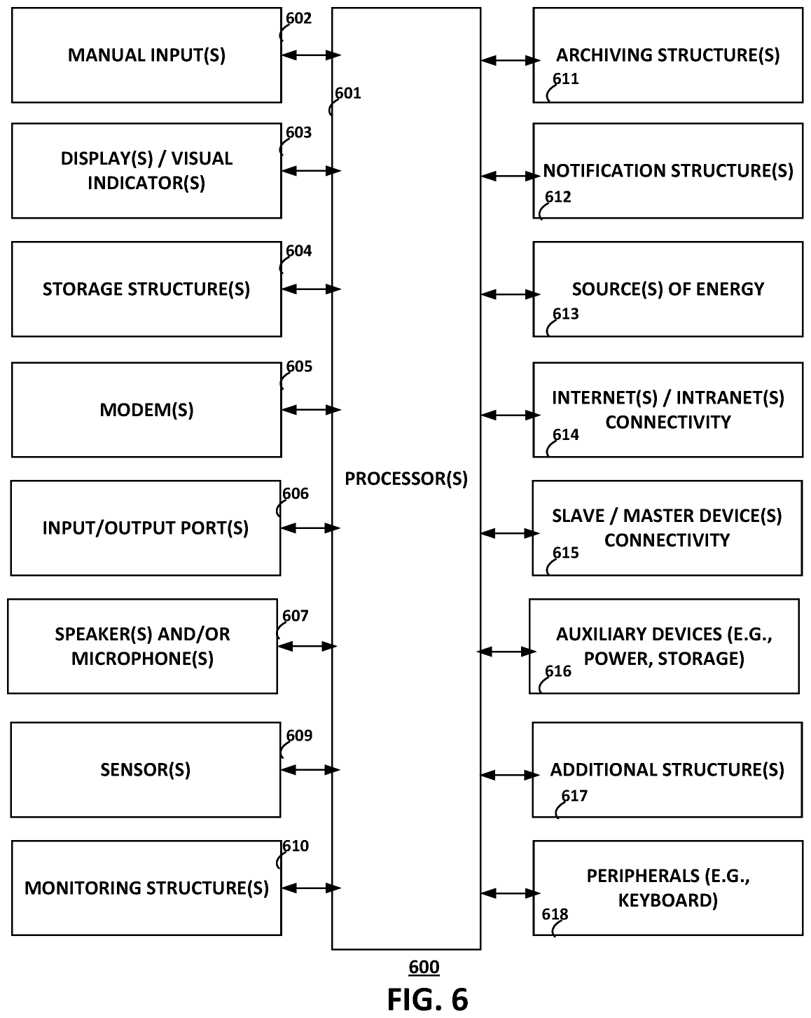

FIG. 6 shows architecture 600 that may be, for example, part of an architecture providing a private and/or public ledger and/or digital asset management and transaction platform. Architecture 600 may include one or more manual input(s) 602, display(s) and/or visual indicator(s) 603, storage structure(s) 605, modem(s) 605, input/output port(s) 606, speaker(s) and/or microphone(s) 607, sensor(s) 609 (e.g., vibration and/or breach sensors to detect potential unauthorized physical access to a device), monitoring structure(s) 610, processor(s) 601, archiving structure(s) 611, notification structure(s) 612 (e.g., automated email and/or text message structures), source(s) of energy 613 (e.g., batteries, generators, external power), internet(s)/intranet(s) connectivity 614, slave/master device(s) connectivity, auxiliary device(s) 616 (e.g., auxiliary power, storage, etc.), additional structures 617, and/or peripheral(s) 618 (e.g., keyboard). Additional structures 617 may be any type of structure such as for example a third-party structure (e.g., third party payment processor) and/or application specific integrated circuits (e.g., ASICs with fabricated structural elements to perform a particular processing function such as a particular blockchain processing function).

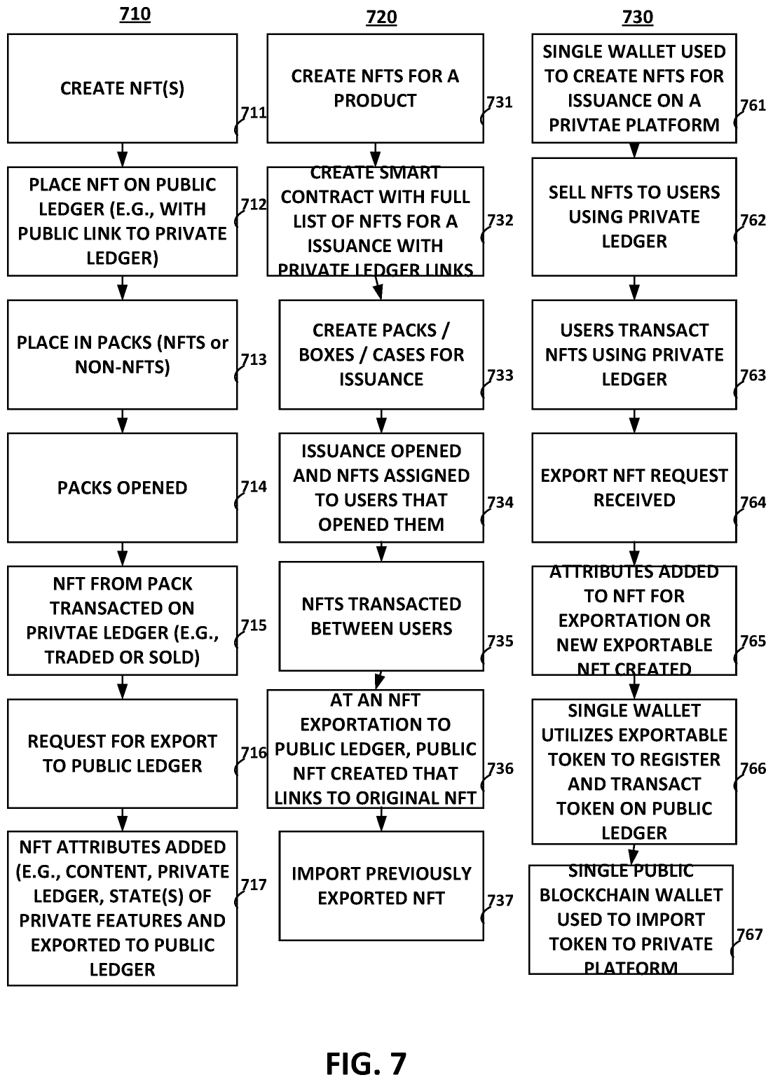

FIG. 7 shows flowchart 710 that may include step 711 in which a digital asset, such as a digital NFT collectible, is created. An NFT may be placed on a public ledger (e.g., with a public website link to a private ledger hosted by or on behalf of a platform that created the NFT) in step 712. The NFT may be placed in a host structure (e.g., packs) in step 713 with other NFTs or non-NFT digital assets. Persons skilled in the art will appreciate that a hosting structure may only have a single digital asset and the hosting structure may be utilized to hide the identity of the digital asset until it is opened. In doing so, for example, a consumer that purchases a pack with a single digital asset may not know what digital asset (e.g., randomly inserted) NFT the consumer has received in the pack until the pack is opened. Packs may be opened in step 714. The NFT exposed from the opened pack may be transacted on a private ledger (e.g., a platform that originated the NFT) in step 715. Step may include a collectible-to-collectible trade, a sale, a donation, or any other type of ownership transaction where, for example, ownership transfers for the NFT between users (e.g., of the same or different platforms). A request to export an NFT may be received in step 716 and NFT attributes may be added and the NFT exported in step 717. Persons skilled in the art will appreciate that an NFT may be created and placed on a ledger without media content itself but with one or more website links to the media content. At exportation, the media content may be added to the NFT. In doing so, the cost and time to create an NFT may be reduced and this cost and time may be realized, for example, at exportation. Persons skilled in the art will appreciate that NFTs may be kept on a private platform and transacted on that private platform without exportation. Exportation may occur to a user of a public or private platform. A user transferring an NFT may, for example, select different modes of transport (e.g., different ledgers) for the NFT for platforms that may utilize different modes of transport. Additional attributes may be added or modified at export such as platform features variables not present in the NFT (e.g., if not added to the NFT at origination) or any attribute modifications that have not yet been updated in the NFT. Accordingly, an exportation through a public blockchain may, for example, provide an ability to update information on the public blockchain.

Flowchart 720 may be included and may include NFTs created for a product in step 731. A smart NFT contract may be created with a list of all NFTs for that product with private ledger links for each NFT in step 732. Persons skilled in the art will appreciate that creating an index NFT and putting an index NFT on one, or more, public ledgers may, for example, provide users with public, third party ledger data on all NFTs of a grouping (e.g., a product) and may provide an improved cost and processing time. Persons skilled in the art will appreciate that a private platform may have a non-smart contract NFT data structure to store data and digital assets and collectibles and such private platform structure may be utilized to create digital assets and hosted structures. Each private structure asset may have a unique identifier and each unique identifier may be, for example, provided in an index NFT. Packs, boxes, cases, may be created for issuance and sale in step 733. Product may be issued and sold and opened and NFTs, or other platform digital asset structures, may be assigned to users that opened them. NFTs, or other private platform digital asset structures, may be transacted between users in step 735. An NFT request for exportation may be requested and at an NFT exportation to a public ledger, a public NFT may be created and/or retrieved that links to the original NFT in the index file (e.g., the original private platform unique identifier in the index file). Accordingly, for example, a public blockchain NFT may be created at exportation and include, for example, reference to an index file and the private ledger unique identifier in that index file such that, for example, a public blockchain NFT history may be traced back to before a pack was opened with the original private unique identifier digital asset. The exported NFT may also include a data structure, for example, that includes a transaction history of at least, for example, ownership transactions that occurred before exportation while on the private platform. A previously exported NFT may be imported in step 737 (or any NFT or digital asset may be imported in step 737). Persons skilled in the art will appreciate that an imported NFT may include a private unique identifier and the consumer receiving the NFT may take possession of the private platform unique identifier while the NFT is on the private platform. Transactions may occur using this private platform unique identifier (e.g., unique token) and, at exportation, the external NFT (e.g., public blockchain NFT) may be updated (e.g., private ledger data may be updated). The platform may use its identity to import and export the NFT so that, for example, ownership integrity on the public blockchain is maintained between important and export. A public blockchain may be provided, however, where sub-identities may transact as if they were the main identity. Accordingly, for example, a platform may have an administrative identity and may provide transacting identities to additional transaction processes in order to, for example, permit a higher number of transactions in a period of time through, for example, a public blockchain.

Flowchart 730 may also be provided and may include step 761, in which a single blockchain wallet (e.g., for a wallet-based blockchain) may be used (e.g., a single identity) to create NFTs for issuance from hosting structures (e.g., packs and boxes) and sale on a private platform. Accordingly, all NFTs for an issuance may have the same manufacturer name as all the NFTs were manufactured with the same wallet. Persons skilled in the art will appreciate that administrative wallets may be provided and children wallets may be assigned rights such as, for example, rights to use the administrator's name when manufacturing NFTs such that, for example, multiple wallets can manufacture NFTs with the same name to provide, for example, improved scalability and burst manufacturing capability. NFTs may be sold to users (e.g., in packs and/or boxes) or directly as unpacked NFTs in step 762. Users may transact NFTs using a private ledger in step 763. Persons skilled in the art will appreciate that a public ledger NFT may not be updated during a private transaction and a private platform may utilize a private ledger to keep track of ownership. A public blockchain, however, may be updated at exportation from the private platform in step 764 after attributes (e.g., multi-state feature variables) and private ledger information is updated ins step 765. Alternatively, for example, a new public blockchain NFT may be created instep 765 and may include or not include private ledger data (e.g., as well as private system functionality data such as data variables for private platform features). The same wallet that created the NFT may be utilized to export, register, and/or transact the token on the wallet-based blockchain in step 766 and that same wallet may be utilized to import an NFT to the private platform in step 767. Persons skilled in the art will appreciate that a single wallet may be utilized by a private blockchain for all import an export events for NFTs for the wallet-based blockchain (e.g., in order to maintain ownership integrity on the wallet-based blockchain).

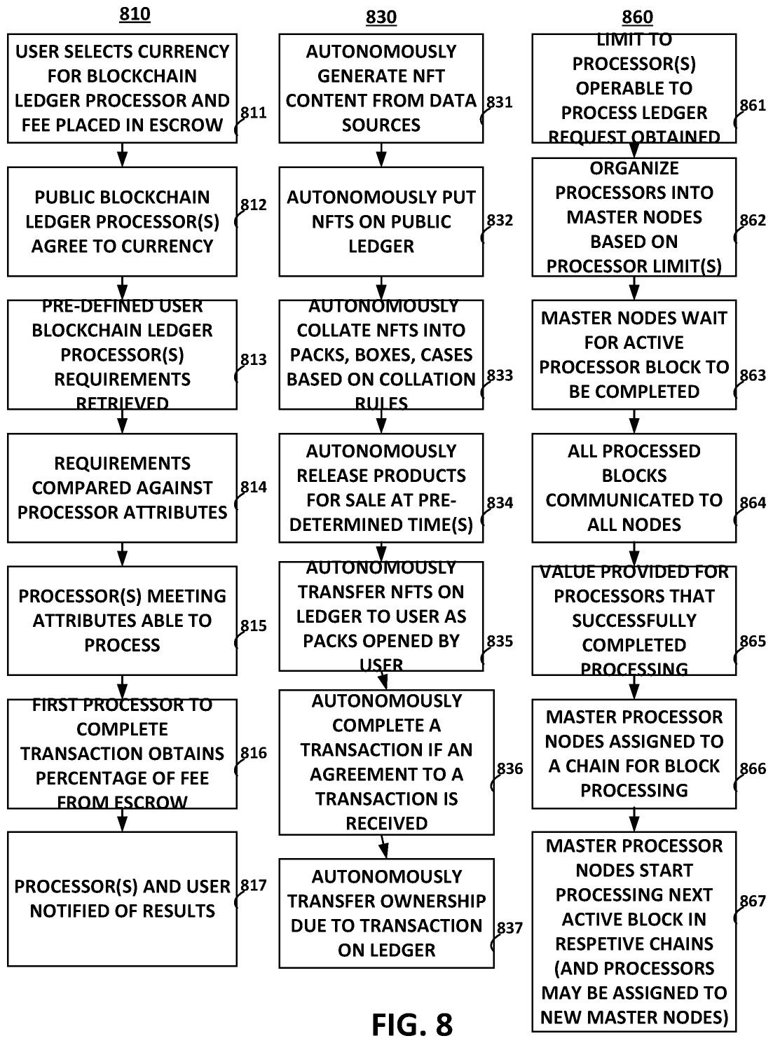

FIG. 8 shows flowchart 810 which may include step 811 in which a user selects a currency for a blockchain ledger processing function (e.g., transaction of an NFT between two entities) and a fee is placed in escrow. One or more public blockchain processor may agree to the currency in step 812. Persons skilled in the art will appreciate that processors may not agree to a currency and such processors may not process that transaction. Persons skilled in the art will appreciate that one or more chains in a multiple chain blockchain my be assigned one or more particular currencies so that processors are assigned to processing chains based, at least in part, on currency qualifications. Accordingly, one chain may utilize US dollars for payment to, for example, processors of that chain and another chain may utilize euros for payment to, processors of that chain. Step 813 may occur in which pre-defined user blockchain ledger requirements are retrieved. For example, a user may include a requirement that processors cannot be utilized that are in a particular country (e.g., not an allied country of the country the user is located in or not a country with a particularly adverse tax policy or the processor has at least a net neutral or net positive environmental impact from processing). Accordingly, the processors may be checked against these user processor requirements. Persons skilled in the art will appreciate that chains of the multiple chain blockchain may be associated with these attributes. Accordingly, for example, a consumer may select a chain that only permits processors with at least a net neutral environmental impact to process their transactions. Requirements may be compared against processor attributes in step 814. Persons skilled in the art will appreciate that an auditing requirement from a certified auditor (e.g., an auditor from a list of auditors) for a particular chain may be required such that third party processors are certified by an approved auditor and the auditor provides a certification process so a chain can identify a certified processor from a non-certified processor. For example, each auditor may provided a list of approved processors for particular attributes and a chain process may require the list of all auditors be retrieved and compared against a processor to permit a valid processing of one or more data blocks to be completed for a particular chain and/or processing function. Processors meeting the requirements (e.g., of the user and/or private platform requesting the processing) may be performed in step 815. First processor to complete a transaction that is a qualifying processor of any requirements (e.g., user requirements) may obtain a processing fee or a percentage of a processing fee in step 816 (e.g., from an escrow). An escrow management fee may be imposed and may be paid, for example, to the originator and/or standards authority (if any) of the blockchain (e.g., of the multiple-chain blockchain). Processor(s) and users may be notified of the results of processing (e.g., the processor or processors that completed and/or how funds were divided and/or verification of a transaction function being successfully performed) in step 813.

Flowchart 830 may also be provided and may include autonomously generating (e.g., from a program) NFT content from data sources in step 831. Accordingly, for example, a program may autonomously have a list of subjects (e.g., a list of birds) and may autonomously search multiple data repositories (e.g., public domain repositories) for the subjects on the list and may retrieve data from the repositories (e.g., pictures of each bird, descriptions of birds, etc.) and use this retrieved data to autonomously generated volume NFTs for volume subjects (e.g., over 1 million NFTs across over 10,000 subjects). A content template may be utilized to create media content (e.g., images of trading cards) and a NFT template (e.g., smart contract template) may be utilized to place data into. The NFTs created may be autonomously placed on a ledger such as a public ledger in step 832 and the NFTs may be collaged into hosting structures (e.g., packs and boxes) in step 833 and may be placed according to randomization and/or collation rules. A product may be released in whole or in parts at pre-determined times for sale in step 834. For example, the first number of packs may be sold at a first pre-determined time and a second number of packs may be sold at a second pre-determined amount of time. Users may have to qualify to purchase packs (e.g., from one particular timed release or multiple timed releases). A qualification my include, for example, purchasing a particular number of unopened packs (or other hosting structures) or spending a particular amount of money for a particular period (e.g., the day of sale or the preceding week of sale). A user may alternatively, for example, have a requirement of needing to own a particular NFT or group of NFTs to be able to purchase a particular NFT, hosting structure, digital asset, box, etc. As packs are opened, any digital assets (e.g., digital NFTs) in the packs may be transferred on the ledger as packs are opened in step 835. If any digital assets are part of valid transaction, the transactions may be autonomously completed in step 836 and ownership may be recorded on a ledger and/or effected through a ledger autonomously in step 837.

Flowchart 860 may also be provided and may include step 861 which may be utilized to limit processors operable to process a requested ledger operation (e.g., a smart contract NFT function). Processors may be organized into master nodes based on processor functionality and/or limitations in step 862. Accordingly, for example, processor groupings may be made based on processor capabilities and certain functions may go to certain groupings. For example, processors that meet a certain pre-determined average communications latency or processing power may be grouped together and may be utilized, for example, for a high-performance chain in a multiple-chain blockchain (e.g., and may carry a higher transaction cost). Similarly, for example, processors not meeting minimum thresholds (e.g., latency and/or processing thresholds) may be limited to particular functions (e.g., ownership transactions and not NFT creation for blockchains with ownership transactions and NFT creation functions). A master node may wait for an active processor block to be completed in step 863. All processed blocks may be communicated to all nodes in step 864. Value ma be then distributed to processors that successfully completed processing in step 865. Master processor nodes may be assigned to a chain for processing data blocks in that chain in step 866. Master processor nodes may start processing next active block in the same chain nodes are processing in step 867 and processors may be assigned to new and/or different master nodes in step 867. For example, suppose a chain includes 100 processors with low latency and fast processing and 10 faster processors with lower latency join, then 10 processors may be removed from the faster node and put on a different node and the new 10 faster processors may be added to the faster node.

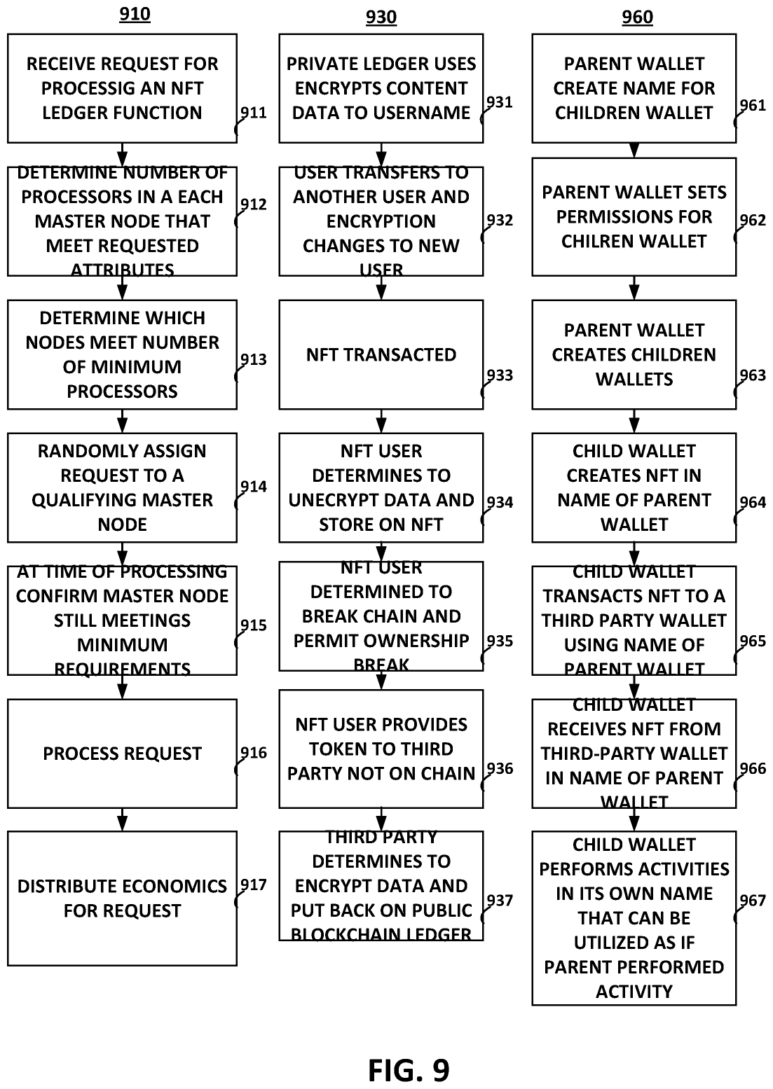

FIG. 9 shows flowchart 910, which may include step 911 in which a request may be received for processing a NFT ledger function. The number of processors in a master node may be determined that meet requested attributes in step 912 and the nodes that meet the determined number of minimum processors (e.g., or other node attributes) may be determined in step 913. A request for processing the transaction may be randomly assigned to qualifying master nodes in step 914. At time of processing, the master node may be re-qualified as well as any processors in the node in step 914. The request may be processed in step 916 and economics may be distributed for the request in step 917.

Flowchart 930 may also be provided and may include step 931 which may include a ledger encrypting content data based on the entity that owns the content (e.g., the digital asset storing the content or referencing the content). The user may then transfer the asset to another surer and the encryption used on the content may change from the sending user to the receiving user in step 932. NFT may be transacted instep 933. NFT user may determine to unencrypt data in step 934. NFT user may also determine to store unencrypted data in an NFT (e.g., permanently unencrypt). NFT user may determine to break an ownership chain of a ledger and permit ownership without being on a particular one or ones of ledgers in step 935. The NFT may then be transacted off chain any number of times in step 936. Third party that received the NFT may then determine to put the NFT back on the chain and/or permanently encrypt the content data (or other data such as attribute data). A blockchain may be provided that enables breaking an ownership chain if, for example, requested by the current owner of the NFT.

Flowchart 960 may also be provided and may include step 961 which may include a parent wallet creating a name for a child wallet (e.g. “Mullen” may create “Mullen.Maple,” “Mullen.Jack,” and “Mullen.Grant). Parent wallet may set permissions for children wallet in step 962 including, for example, performing functions using the parent wallet name. Persons skilled in the art will appreciate that a ledger may be provided where children wallets may perform with their own names all, a portion of, or parent permitted functions that a parent wallet may perform. Parent wallet creates children's wallets in step 963. A child wallet may create a digital asset, or perform any ledger function, in the name of a parent wallet in step 964. Child wallet may transact an NFT to a third party wallet using the name of a parent wallet in step 965. A child wallet may receive NFT from a third-party wallet in the name of a parent wallet in step 966. A child wallet may perform activities in its own name that can be utilized as if parent performed the activity in step 967.

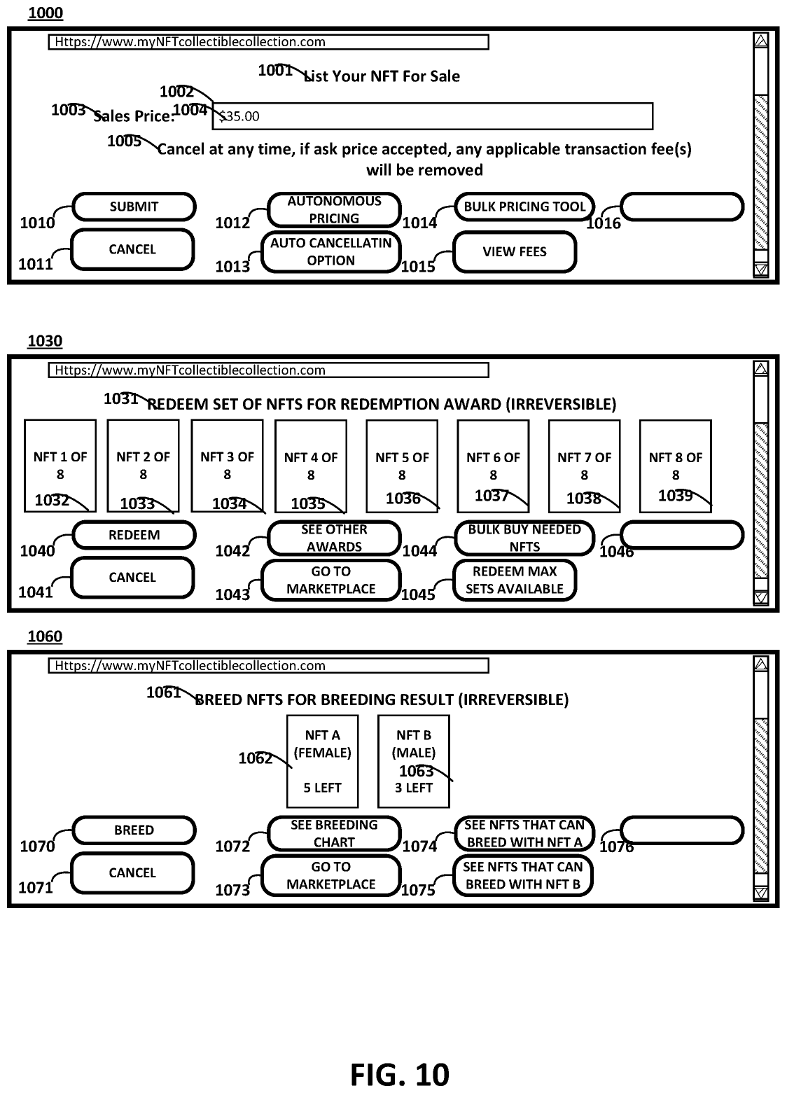

FIG. 10 shows interface 1000 that may include indicia 101, 103, and 105. Interface 1000 may also include manual input area 1004 and options 1010-1016. Interface 1000 may be utilized, for example, to list a digital asset (e.g., an NFT) for sale as well as provide a sales price. Option 1010 may provide submission of a digital asset to one or more marketplaces with a sales price. Autonomous pricing may provide, for example, suggested pricing based, at least in part, on prior sales, bulk pricing option may be utilized to price more than one (e.g., more than two) digital assets at a time and list the digital assets on one or more marketplaces in bulk. Option may cancel a transaction (e.g., cancel a marketplace listing), option 1013 may include auto-cancellation options such as, for example, a particular number of copies of an NFT are sold within a period of time, option 1015 may be utilized to view fees associated with listing and/or a sale/purchase of a digital asset, option 1016 may include additional options.

Interface 1030 may also be provided and may include an achievement feature where a particular grouping of digital collectibles (e.g., NFTs) may be redeemed for one or more awards (e.g., one or more achievement NFTs). NFTs 1032-1039 may be provided to show the NFTs that are needed to earn an achievement as well as whether or not a user has particular ones of those NFTs. A consumer may be asked to redeem or destroy qualifying NFTs to earn a reward. A reward NFT may be unlimited in number or limited in number. An award may be earned during a period of time or may not have a period of time associated with earning a reward. A user may redeem qualifying NFTs in 1040. A redemption may change the state of an NFT so that the NFT can still be transacted, but that the NFT can not be used again for that award and/or any other awards. A NFT may have a number of redemptions available (e.g., 1, more than 2, more than 2). An award NFT transaction may be cancelled in step 1041. Other awards for a set or a platform may be viewed through option 1042. A marketplace may be accessible through option 1043. Bulk buy needed NFTs may be provided in option 1044 (e.g., bulk buy cheapest priced NFTs needed to complete an award on interface 1030). Redeem max sets available option 1045 may be provided such that a suer that has multiple sets of groupings for an award can redeem all groupings at once for the associated number of awards. Option 1042 may include accessibility to any option or feature.

Interface 1060 may also be provided and may provide a breeding interface for two (or more than two) NFTs. For example, NFT 1062 may breed with NFT 1063. Each NFT may have a particular number of replenishable or non-replenishable breeding events they may be a part of. A breeding event may have a particular set of requirements to occur (e.g., two NFTs of the same type, such as a bird, or sub-type, such as a bird species). Option 1070 may be utilized to breed NFTs (e.g., which may generate one or more new NFTs such as children NFTs). Option 1071 may be utilized to cancel a breeding event. Step 1072 may be utilized to view a breeding chart of the outcomes of various breedings. Persons skilled in the art will appreciate that breeding may be impacted by factors outside of an NFT such as, for example, the time of the day, time of the year, status of owner of the NFT, or any other platform attribute (e.g., user attribute) or non-platform attribute. Options 1074 may be utilized to see qualifying NFTs that can breed with an NFT (e.g., NFT 1062). Options 1075 may be utilized to see qualifying NFTs that can breed with an NFT (e.g., NFT 1063).

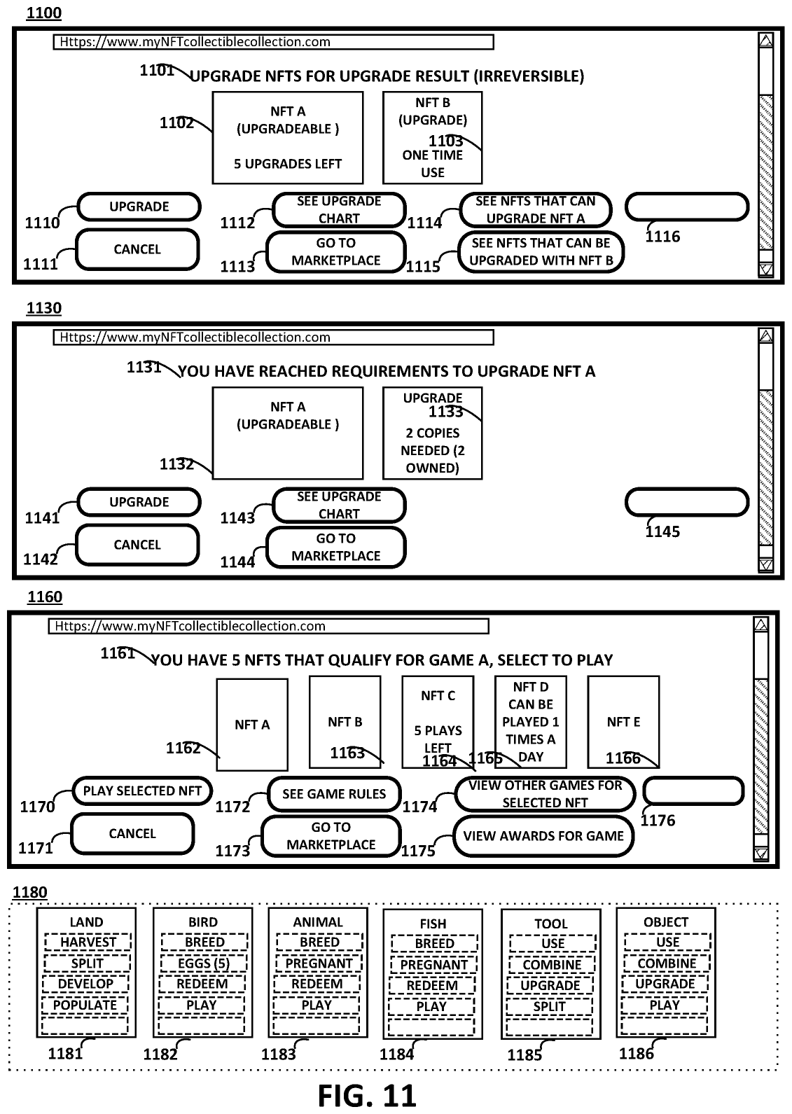

FIG. 11 shows interface 1100 that may include, for example, an interface for upgrading and/or downgrading an NFT. Description 1101 may be included to include information associated with an upgrade and/or downgrade. Interface 1100 may include NFTs 1102 and 1103 (e.g., visual representations of an NFT) that may be upgraded. Upgrading an NFT may require, for example, a qualifying NFT be used. For example, upgrading an egg NFT to a child NFT to an adult NFT may require, for example, a particular environment NFT. For example, if an egg NFT needs a marshland to hatch, the egg NFT may be upgraded into a child NFT using a marshland NFT. NFTs may have limited number of uses for upgrades (or be upgradable/downgradable a certain number of times) or an unlimited number of uses. Uses may be replenishable (e.g., upon earning an award or after a period of time). An NFT may be upgraded (e.g., a multiple-state variable changed in the NFT) in step 1110. An upgrade process may be cancelled in step 1111. An upgrade chart may be provided in step 1112 and accessible to a marketplace may be provided in step 1113. NFTs that may be used to upgrade an NFT may be provided in option 114. NFTs that may be upgraded with an NFT may be shown in step 1115. Persons skilled in the art will appreciate that to NFTs may be upgraded together. For example, a person NFT may marry another person NFT in order for each NFT to become a married person NFT.

Interface 1130 may also be provided any may be utilized to upgrade NFT 1133 utilizing one or more NFTs 1133. Interface 1030 may include upgrade option 1131, cancel option 1142, upgrade chart retrieval option 1143, marketplace option 1144, and additional options 1145.

Interface 1160 may also be provided and may be utilized to play a game once a particular number of qualifying events (e.g., ownership of a particular grouping of NFTs) occurs. For example, NFT 1162-1166 may be utilized to play a game. For example, 5 NFTs may be needed of basketball players (having a particular distribution of positions) to play a basketball game. Hitting a particular milestone (e.g., winning, earning a particular number of points) in a game may award one or more NFTs or other functionality (e.g., ability to purchase a particular pack and/or a discount on a future purchase). A game may also list qualifying NFTs and one, or more than one, NFTs may be selected to play the game. Option 1170 may be utilized to play a game with one or more selected NFTs. Option may be utilized to cancel an interface (e.g., interface 1160) or a request. Game rules may be accessible via option 1172. Marketplace may be accessible via option 1173. View other games for the selected NFTs may be accessible through option 1174. Awards for a game may be accessible via option 1175. Additional options and/or games may be provided via option 1176.

NFTs topologies 1180 may also be provided. NFTs may include particular features and such features may be stored as attributes in an NFT (or data associated with an NFT such as associated with a unique identifier for an NFT). For example, NFTs 1181-1186 may have various variables associated with various attributes and functions. Interfaces on NFTs 1181-1186 may be provided so a user (e.g., an owner) can utilize a feature. For example, land NFT 1181 may be harvested by the owner of land 1181 clicking a harvest option. Land 1181 may include, for example, harvest, split, develop, populate, and any other option. Bird NFT 1182 may include any number of options including breeding, eggs, redeem, and play (e.g., in a game). Animal NFt may include, for example, any number of options including a breed option, pregnant option, redeem option, play option. Persons skilled in the art will appreciate that an option may be a state that provides additional functionality (e.g., rewards). For example, after breeding, a period of time may lapse before an NFT is upgraded to pregnant and a pregnant NFT may be utilized, for example, in the earning of one or more awards. Fish NFT 1184 may include a breed option, pregnant option, redeem option, and play option. Tool NFT 1185 may include a use option, combine option, upgrade option, and split option. Object NFT 1186 may include a use option, combine option, upgrade option, and redeem option.

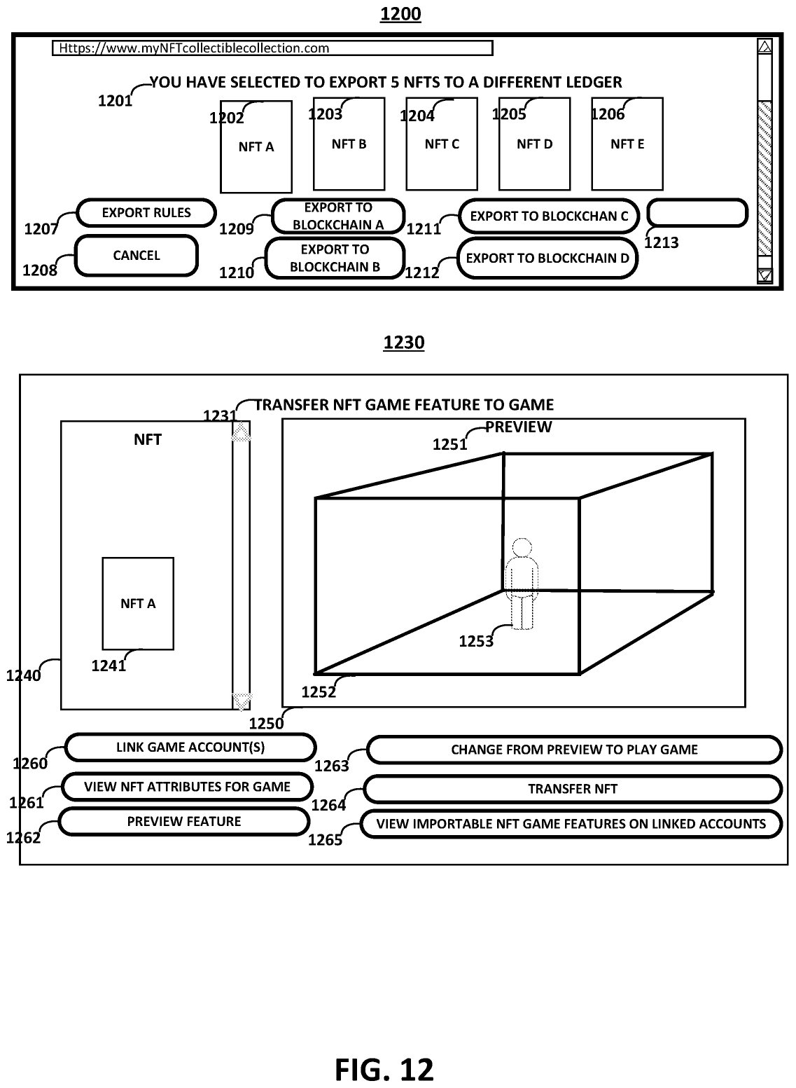

FIG. 12 shows interface 1200 that may include an interface for exporting one or more digital assets (e.g., digital NFT collectibles) to a different system (e.g., a different ledger). Description 1201 may be utilized to provide a description of an action requested. NFTs 1202-1206 may be selected, for example, for export (e.g., to one or more users of a different platform through one or more blockchains such as a public blockchain). Export rules may be provided through option 1207 and an action may be canceled through option 2018. Export option 1209 may be utilized to export through one blockchain. Export option 1210 may be utilized to export through a different blockchain. Option 1211 may be utilized to export through yet another blockchain. Option 1212 may be utilized to export yet through another blockchain. Option 1213 may be utilized to access additional options.

Interface 1230 may also be provided and may include a game feature (e.g., an in-game item) that may be previewed in window 1250 using environment 1252. If an object (e.g., a character) is desired to be utilized to preview an item, that object may be provided as object 1253. For example, a user may earn an in-game sword and utilize window 1250 to preview use of the sword if the user transfers the sword into one or more games that can utilize the sword. Accordingly, window may be utilized to show or preview the in-game impact of an in-game feature (e.g., in-game content) that may be associated (e.g., stored) in an NFT (e.g., NFT represented by NFT representation 1241). One or more gaming accounts may be linked in option 1260. NFT attributes associated with a game may be viewed in step 1261. In-game content and/or feature may be previewed in step 1262. Option 1263 may be utilized to use the in-game content in a game (e.g., transfer the content permanently from a private platform to a game platform). Option 1264 may be utilized to transfer an NFT. Option 1265 may be utilized to view importable NFT game features on linked accounts. For example, a user may find a sword in a game and import it to a private platform for sale and/or trading from the game using, for example, interface 1230.

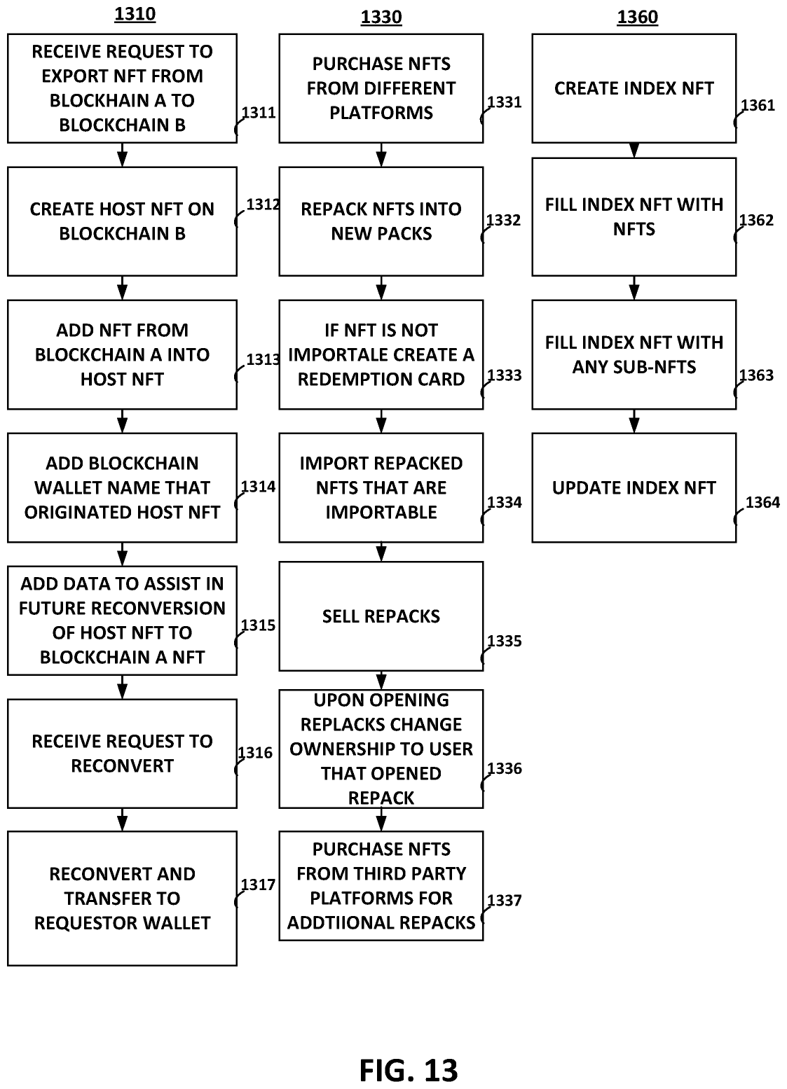

FIG. 13 shows flowchart 1310 that may include step 1311 in which a request may be received to export an NFT from Blockchain A to Blockchain B. A host NFT may be created on blockchain B in step 1312 and an NFT from blockchain A may be added to the host NFT in step 1313. A blockchain wallet name may be added that originate the host NFT in step 1314 and data to assist in future reconversion of host NFT to blockchain A NFT may be utilized in step 1315. A request may be received to reconvert in step 1316 and reconversion and transfer to requestor account may occur in step 1317. Accordingly, for example, an NFT may be transferred into a new platform and may be placed into an NFT created on that new platform and the new NFT may be transacted. If the transacted NFT is desired to be exported to the original blockchain, then the nested NFT may be removed and transacted. Alternatively, for example, the nested NFT may be kept with its host NFT and transferred along with the platform that nested the NFT. In doing so, a future owner may return to the nesting platform and request that the NFT be un-nested. Any number of hostings/nestings may occur as an NFT is transacted through different ledgers (e.g., public blockchains).

Flowchart 1330 may also be provided and may include step 1332 in which digital assets (e.g., NFTs) may be purchased (e.g., post pack opening) from third party platforms and repacked into new packs in step 1332. Persons skilled in the art will appreciate that the platform performing re-packs may include its own NFT collectibles in the re-packs (e.g., previously issued and sold collectibles that were bought back or new collectibles such as new NFTS part of a new collectible set make for the repacks). If an NFT is not importable, a redemption digital asset (e.g., digital redemption card or digital redemption NFT) may be created with instructions on how to initiate a transfer of the asset on the third party platform (e.g., call a number and provide a code provided on the redemption card or identify the customer as the owner of the redemption card and redeem the redemption card). Improted NFTs for the repacks may be imported in step and repacks may be sold ins step 1335. Upon opening repacks, ownership of digital assets in the repacks may be changed to the opening user in step 1336. New NFTs from third party platforms may be purchased for additional repacks in step 1337. Accordingly, third party NFTs that were opened on third-party systems and transacted on third-party systems may be purchased and re-packed in new packs for sale on a different platform.

Flowchart 1360 may also be provided in which an index NFT may be created for an issuance (e.g., a repack issuance) in step 1361. The Index NFT may be filled with identifiers to the NFTs associated with the index in step 1362. Persons skilled in the art will appreciate that NFTs may include nested NFTs and such next NFTs may also have unique identifiers, and associated data, provided in an index NFT in step 133. At any time an index NFT may be updated in step 1365 (e.g., if an NFT or sub-NFT was destroyed.)

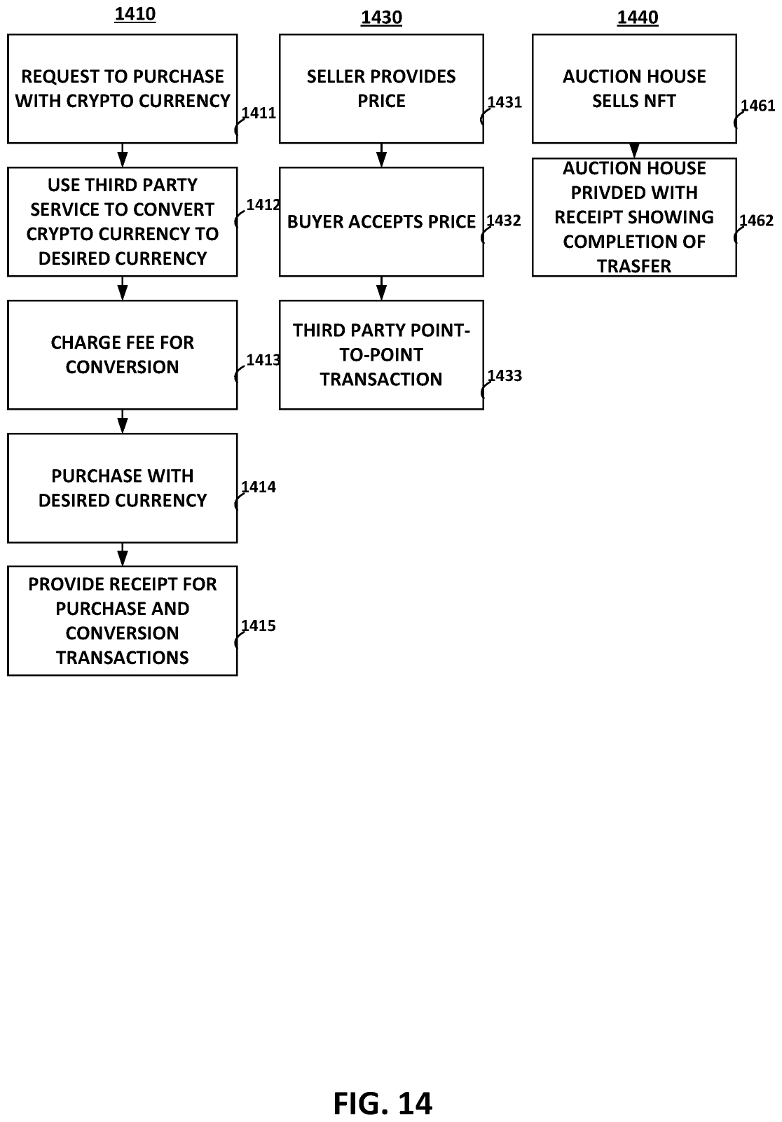

FIG. 14 shows flowchart 1410 and may include step 1411 in which a request to purchase a digital asset (e.g., a digital sports collectible NFT) may be performed. A third-party service may be utilized to convert a cryptocurrency supplied by a buyer to a desired currency (e.g., US dollars) in step 412 and a fee may be charged for this conversion in step 1413. A purchase may be completed with the desired currency in step 1414 and a receipt may be provided for the purchase and/or conversion transactions in step 1415.

Flowchart 1430 may also be provided and may include step 1413 in which a seller provides a price for an NFT collectible. A buyer may accept a price in step 1432 and a third party point-to-point transaction may be initiated outside of the platform providing the sale of the NFT and the NFT may be transferred upon the third-party point-to-point transaction being completed and verified (e.g., via a transaction verification process with the third party point-to-point transaction provider).

Flowchart 1460 may also be provided and may include step 1461 in which an auction house may sell an NFT. A buyer may utilize a platform to transaction the purchased NFT through a requested ledger and/or platform. The auction house may be provided with a receipt showing completion and details of the transfer in step 1462. The auction house may provide the receipt to both parties involved in the transaction in step 1462. Persons skilled in the art will appreciate that a platform may include an ability to auction an item, such as an NFT, and all bids or qualifying bids associated with the item (e.g., as well as associated data such as time and user that made the auction bid) may be processed and/or recorded, for example, on a ledger such as a private blockchain ledger or a public blockchain ledger.

Persons skilled in the art will appreciate that elements of any device herein may be utilized in any device herein. Persons skilled in the art will also appreciate that the present invention is not limited to only the embodiments described. Instead, the present invention more generally involves uniquely identified data and secure methods for storing and operating on the same. Persons skilled in the art will also appreciate that the apparatus of the present invention may be implemented in other ways then those described herein. All such modifications are within the scope of the present invention, which is limited only by the claims that follow.

What is claimed is:

1. A multiple ledger non-fungible token comprising:
a website link to a NFT collectible media content;
a public NFT unique identifier for a public NFT blockchain, wherein a public ownership change transaction is operable to be initiated on said public NFT blockchain based, at least in part, on said public NFT unique identifier; and
a NFT private unique identifier for a private NFT transaction platform; and
a private NFT ledger data wherein a private ownership change transaction is operable to be initiated on said private NFT transaction platform transaction based, at least in part, on said private NFT unique identifier and a record of said private NFT ownership change transaction is operable to be stored in said private NFT ledger data.

2. The multiple-ledger non-fungible token of claim 1, wherein said non-fungible token is operable to be processed on a blockchain having multiple parallel chains of processing different data blocks.

3. A multiple-chain blockchain comprising:
a first chain of blocks for processing by a first plurality of remote processing systems, wherein said first plurality of remote processing systems are assigned to process said first chain of blocks;
a second chain of blocks for processing by a second plurality of remote processing systems, wherein said second plurality of remote processing systems are assigned to process said second chain of blocks and assigned not to process said first chain of blocks; and
a third chain of blocks for processing by a third plurality of remote processing systems, wherein said third plurality of remote processing systems are assigned to process said third chain of blocks and not assigned to process said first or second chain of block, said first, second, and third plurality of remote processing system cannot move to processing a subsequent block of said respective first, second, and third chains of blocks until the current block of said respective first, second, and third chains of blocks have been processed and said first, second, and third plurality of processing systems cannot be utilized to process blocks from a chain outside the respective chain of blocks said first, second, and third blocks are processing.

4. The multiple chain blockchain of claim 3, wherein said first plurality of blocks includes a first multiple ledger non-fungible token.

5. A method comprising:
creating a non-fungible token (NFT) for a public blockchain ledger having a read-only manufacturer name associated with the manufacturer of said non-fungible token and a read-online private ledger, wherein said non-fungible token (NFT) is registered on said public blockchain ledger;
performing a private ownership transactions with said NFT after said NFT is registered on a private ledger, wherein said read-only private ledger is updated; and
performing a public ownership transaction, after said private ledger is updated, said NFT to said public blockchain ledger.

6. A method comprising:
creating a non-fungible token (NFT) for a public blockchain ledger having a read-only manufacturer name associated with a manufacturer of said non-fungible token and a read-online private ledger, wherein said non-fungible token (NFT) is registered on said public blockchain ledger by said manufacturer;
performing a private ownership transactions with said NFT from said manufacturer to a third party after said NFT is registered on a private ledger, wherein said read-only private ledger is updated with said private ownership transaction;
performing a public ownership transaction after said private ledger is updated from said manufacturer to a second third party, wherein said public blockchain ledger is updated with said public ownership transaction; and
viewing on said NFT said public ownership transaction and said private ownership transaction.
